(19) United States
(12) Patent Application Publication
(10) Pub. No.: US 2020/0172142 A1
(43) Pub. Date: Jun. 4, 2020

(54) Z-FOLDABLE STROLLER AND ACCESSORIES

(71) Applicants: LARKTALE PTY LTD, Brookvale (AU); DONGGUAN ALWAYS SHINE DAILY ARTICLE CO., LTD, Dong Guang City, Guangdong (CN)

(72) Inventors: Anthony Michael YOUNG, Brookvale (AU); Peng Yao YANG, Dong Guang City (CN)

(73) Assignee: Dynamic Motion, LLC, Richmond, VA (US)

(21) Appl. No.: 16/246,675

(22) PCT Filed: Jul. 12, 2017
(86) PCT No.: PCT/AU2017/050715

§ 371 Date: Jan. 14, 2019

(30) Foreign Application Priority Data
Jul. 12, 2016 (CN) 201510544566.X
Jul. 12, 2016 (CN) 201610544569.3
Jul. 12, 2016 (CN) 201620729112.5
Jul. 12, 2016 (CN) 201620729113.X
Jul. 12, 2016 (CN) 201620729357.8
Jul. 12, 2016 (CN) 201620729358.2
Aug. 12, 2016 (CN) 201620872619.6
Sep. 2, 2016 (AU) 2016903527
Sep. 2, 2016 (AU) 2016903528
Sep. 2, 2016 (AU) 2016903529
Sep. 2, 2016 (AU) 2016903530
Sep. 2, 2016 (AU) 2016903531
Sep. 2, 2016 (AU) 2016903533

(51) Int. Cl. B62B 7/06; B62B 7/14; B62B 9/20

(52) U.S. Cl. CPC B62B 7/06; B62B 7/142; B62B 2205/22; B62B 2205/003; B62B 9/20

(57) ABSTRACT

A collapsible stroller frame assembly which is selectively configurable in an unfolded configuration for carrying a child or infant, and a folded configuration for compact storage or transport in a vehicle, the frame assembly comprising: a front wheel frame with a front wheel assembly; a rear wheel frame with a rear wheel assembly; a lower hinge connecting the front wheel frame to the rear wheel frame in articulated manner, a seat frame hingedly connected to the lower hinge; an upper hinge connected to the seat frame at a position spaced from the lower hinge; a handle frame connected to the upper hinge, a manual release for user actuation; and a mechanical link between the upper and lower hinges; wherein the lower hinge is lockable to hold the seat frame, the front wheel frame and the rear wheel frame in the unfolded configuration, and unlockable to allow relative rotation of the seat frame, the front wheel frame and the rear wheel frame into the folded configuration; and the upper hinge is lockable to hold the handle frame and the seat frame in the unfolded configuration, and unlockable to allow rotation of the handle frame relative to the seat frame into the folded configuration; such that, user actuation of the manual release unlocks the upper hinge for rotation of the handle frame relative to the seat frame, and the mechanical link unlocks the lower hinge in response to a predetermined angular rotation of the handle frame relative to the seat frame.

### FIELD OF THE INVENTION

The present invention relates to strollers for infants and children. In particular, the invention relates to strollers with collapsible frames that fold into a more compact configuration for ease of storage and portability, as well as accessories such as bassinets and snack trays for use with strollers of this type.

### BACKGROUND OF THE INVENTION

The different aspects addressed by the present invention will be set out below under separate subheadings to facilitate an understanding of the various improvements which the invention seeks to provide in relation to strollers.

### Background: Z-Folding Frame

Strollers, prams and push chairs (as they are sometimes known) are commonly used by parents to transport infants and children during pedestrian outings. However, due to their size, strollers can be inconvenient to store or transport in a vehicle. In light of this, strollers fold or ‘collapse’ into a more compact configuration when not in use.

To provide a more compact folded configuration, some collapsible strollers have particularly complex hinged and telescopic frame structures. While this allows the stroller to fold down into a smaller size, the complexity of the frame increases the production costs. Similarly, greater complexity of the frame tends to require a more complicated folding procedure. For example, retracting telescopic sections and locking or unlocking various frame hinges and so on require the user to follow a relatively protracted protocol of steps when folding or unfolding a stroller. However, parents of young children require this operation to occur as quickly and simply as possible.

Australian Registered Designs 336,075, 336,076 and 336077 show a collapsible stroller of the type that has a single main hinge that connects a handle frame, a rear wheel frame and a front wheel frame. In the folded configuration, the handle, front wheel and rear wheel frames all rotate about in the single hinge to overlay each other in the folded configuration. While this form of collapsible stroller is adequate for many parents, a more compact folded configuration can be achieved through the use of a so-called ‘Z-folding’ frame assembly. Australian patent application AU 2012268804 is an example of a Z-fold collapsible stroller which uses at least two hinges, ie. an upper hinge and a lower hinge, so that the folded frame assembly is significantly shorter than that possible with a single hinged frame assembly.

As discussed above, the added complexity of a Z-folding frame assembly increases the production costs. Similarly, the more complex frame has a more involved folding and unfolding process. For example, the stroller frame disclosed in the above referenced AU '804 application is devised such that the stroller will only move to its fully folded position after a specified series of manual actions. Firstly, the user presses their palms on side projections extending from opposite sides of the stroller. Then a pair of handle triggers are drawn upwards. This in turn draws a push rod upwards to simultaneously unlock the lower frame hinge and the upper frame hinge. The user needs to stoop to reach the handle triggers, and any weight placed on the handle frame tends to cause the frame to collapse more quickly than expected once the upper and lower hinges have been simultaneously unlocked. Furthermore, the rear wheel frame must then be separately unlocked via a manual lock release handle to complete the folding process. The rear wheel frame pivots about an axis which is slightly offset from the lower hinge axis which, strictly speaking, gives the stroller three (rather than two) hinge axes, to achieve the required ‘Z-fold’. Offsetting these hinge axes from each other reduces the compactness of the folded configuration.

### SUMMARY OF THE INVENTION—Z-FOLDING FRAME ASSEMBLY

With these issues in mind, the present invention provides a frame assembly for a collapsible stroller, the frame assembly being selectively configurable in an unfolded configuration for carrying a child or infant, or a folded configuration for compact storage or transport in a vehicle, the frame assembly comprising:

a front wheel frame with a front wheel assembly;

a rear wheel frame with a rear wheel assembly;

a lower hinge for hingedly connecting the front wheel frame to the rear wheel frame,

a seat frame hingedly connected to the lower hinge;

an upper hinge connected to the seat frame at a position spaced from the lower hinge;

a handle frame connected to the upper hinge,

a manual release for user actuation; and

a mechanical link between the upper and lower hinges; wherein

the lower hinge is lockable to hold the seat frame, the front wheel frame and the rear wheel frame in the unfolded configuration, and unlockable to allow relative rotation of the seat frame, the front wheel frame and the rear wheel frame into the folded configuration; and

the upper hinge is lockable to hold the handle frame and the seat frame in the unfolded configuration, and unlockable to allow rotation of the handle frame relative to the seat frame into the folded configuration; such that,

user actuation of the manual release unlocks the upper hinge for rotation of the handle frame relative to the seat frame, and the mechanical link unlocks the lower hinge in response to a predetermined angular rotation of the handle frame relative to the seat frame.

By incorporating a mechanical link between the upper and lower hinges, the invention allows the frame assembly to collapse with a Z-fold mechanism without having to actuate multiple release mechanisms in a specified sequence. A single user actuated release initiates the Z-folding process, and this initial step in the folding process is the trigger for unlocking the remaining steps of the folding process. This allows the stroller to have a Z-folding mechanism for a particularly compact folded configuration, while avoiding a complicated set of steps to unlock each of the frame elements. The user need only actuate a single release mechanism instead of a series of releases to complete separate stages of the folding process. The present Applicants have utilised the early stages of the folding process itself to unlock subsequent stages. This multi-stage approach to unlocking and collapsing the frame assembly provides the user with a safer and more controlled process compared to the simultaneous unlocking of the both the upper and lower hinges offered by some of the prior art strollers.

Preferably, the handle frame supports the user actuated release for unlocking the upper hinge.

Placing the user actuated release on the handle is convenient and avoids any bending or stooping. Furthermore, the user can continue to hold the handle as it rotates relative to the seat frame until the lower hinge is unlocked. This provides the user with greater control of the first stages of the folding process.

In some embodiments, the handle frame has two spaced apart, generally upright frame members connected at their upper ends via a cross member forming a handle, and the user actuated release has a pair of retractable triggers, one of the retractable triggers being positioned on each of the spaced apart frame members respectively, proximate the handle. Preferably, the handle frame is telescopic such that simultaneous retraction of both the retractable triggers allows the handle to telescope towards the upper hinge such that a portion of the user actuated release housed within the handle frame interacts with the upper hinge to unlock the upper hinge.

Preferably, the handle frame is rotatable towards the rear-wheel frame in response to unlocking the upper hinge.

Optionally, the handle frame is approximately parallel to the wheel base (i.e. approximately horizontal), when at the predetermined angular rotation between the handle frame and the seat frame, at which point the mechanical link between the upper hinge and the lower hinge unlocks the lower hinge such that the seat frame is rotatable towards the front wheel frame.

Preferably, the frame assembly further comprises a latch for releasably securing the front wheel frame, the rear wheel frame, the seat frame and the handle frame in the folded configuration, wherein during use the latch automatically secures the frame assembly upon movement to the folded configuration.

Preferably, the latch comprises a spigot extending from the seat frame, a hook formation extending from the handle frame and a hasp extending from the rear wheel frame wherein the hook engages the spigot at a mid point, and the hasp engages with an end of the spigot.

Preferably, the spigot is mounted for movement between a frame secured position and a frame released position, wherein the spigot is biased to the frame secured position, and manual actuation of the spigot to the release position allows the frame assembly to move to the unfolded configuration. Preferably, the hook engages the spigot upon rotation of the handle frame and the seat frame to overlay the front wheel frame. Preferably, the frame assembly is configured such that user lifting of the handle upwards after the hook engages the spigot draws the lower hinge upwards to rotate the rear wheel frame towards the front wheel frame via gravity. In a further preferred form, suspending the frame assembly by the handle above the ground, after the hook has engaged the spigot, allows the rear wheel frame to rotate adjacent to the front wheel frame where the hasp automatically engages the end of the spigot, such that the frame assembly is secured in the folded configuration.

It will be appreciated that folding the collapsible stroller is comparatively simple for the user. The release triggers are pulled, and pressing down on the handle allows it to telescope into the two spaced and generally upright frame members. This action pushes part of the release actuator into the upper hinge to move a biased locking pin to an unlocked position. Then the handle naturally drops towards the rear wheel frame until the lower hinge unlocks and the user continues to allow the handle frame and the seat frame to hinge downwards and forwards towards the front wheel frame. At the front wheel frame, the hook on the handle frame automatically engages the spigot extending from the seat frame at which point the user stops lowering the handle and starts to lift the handle. With the handle frame, and the seat frame now locked in the folded configuration, lifting the handle draws the lower hinge upwards so that the rear wheel frame naturally falls towards the front wheel frame as the folded frame members adopt a more vertical configuration hanging from the handle. As the frame assembly is lifted from the ground, the rear wheel frame is adjacent the front wheel frame which, in turn, is adjacent to the seat frame. The hasp on the rear wheel frame locks over the spigot to hold the rear wheel frame and the front wheel frame from rotating back away from the seat frame and the handle frame. In essence, the folding process simply involves allowing the frame to collapse towards the ground in a controlled way using the handle, the lifting back off the ground by the handle to complete the folding process.

The unfolding process is also straight forward. Upon releasing the latch, the handle is lifted to rotate the seat frame away from the front wheel frame and towards the rear wheel frame. The lower hinge locks the front wheel frame and the seat frame in a predetermined relative position and subsequently the upper hinge locks at a predetermined angular position of the handle frame relative to the seat frame. Finally, the handle is used to push downwards so that the rear wheel assembly rolls away from the front wheel assembly, until the lower hinge locks the rear wheel frame in the unfolded configuration.

Preferably, the frame assembly further comprises a safety bar for hinged attachment to the handle frame wherein during use the safety bar extends forward to surround and protect a child sitting in the stroller seat.

Preferably, the safety bar is configured to be folded upwards to lie flush against the handle frame such that the frame assembly can be moved to its folded configuration without first detaching the safety bar.

Preferably, the frame assembly further comprises a retractable hood pivotally attached to the handle frame to extend above the seat for weather and sun protection. Preferably, the retractable hood can be retracted to lie flat against the handle frame such that the frame assembly can be moved towards its folded configuration.

The seat base may advantageously include a footrest extending from a hinge mechanism at a front edge of the seat base. Preferably, the hinged mechanism for the foot rest allows the footrest to adopt one of a predetermined range of different angles relative to the plane of the seat wherein the footrest can remain in any one of the predetermined range of different angles as the frame assembly is moved to the folded configuration.

In a preferred embodiment, the handle frame includes telescopic frame members to allow the handle to move closer to the upper hinge when the frame assembly is in the folded configuration.

In some embodiments, the frame assembly can support a snack tray having a tray with at least one shallow recess for holding snacks during use of the stroller, and a snap locking formation positioned to one side of the tray for snap locking engagement with the safety bar. Preferably, the snack tray is configured such that the snap locking formation is capable of snap locking the snack tray to the safety bar such that the tray selectively extends forward of the safety bar, or extends rearward of the safety bar. Preferably, the snack tray is also configured for snap locking with the handle. Preferably, the snap locking formation is configured for selectively snap locking the snack tray to the handle such that the snack tray extends forward of the handle or rearward of the handle. Optionally, the handle has a mounting sleeve for engagement with the snap locking formation. Optionally, the safety bar has a mounting sleeve for engagement with the snap locking formation.

### Background: Folding Bassinet

A stroller, and in particular the above described z-frame stroller embodiments, may also be used to transport babies and infants that are not yet able to sit. These very young infants lie in a bassinet when being carried by the stroller.

Normally, a pair of spaced adaptors snap lock to either side of the seat frame for releasably mounting the bassinet to the stroller. Bassinets provide a padded cot for the infant with a handle for portability, even while the infant sleeps. Usually, the bassinet will also have a retractable hood to shade the infant when necessary.

Product safety laws place high design standards on bassinets. In particular, bassinets for transporting babies must be very robust. The strength and structural rigidity is provided by the bassinet frame that is mostly concealed within the soft outer components.

While not as large as strollers, bassinets still occupy a considerable space, even with the hood in a retracted position. Constructing a bassinet such that it folds into a smaller configuration is problematic as the specified minimum strength and stiffness require the frame members to be excessively large. The size and strength of a central folding hinge for the bassinet would require a construction that is impractically large and/or cost prohibitive.

### SUMMARY OF THE INVENTION—FOLDING BASSINET

In view of the above considerations, a bassinet has been developed which folds to a more compact folded configuration using a folding bassinet frame assembly comprising:

a bed board having a first portion and a second portion, the first portion and the second portion from being hinged together and configured to unfold to provide a support surface for an infant;

a first rim and a second rim spaced from the bed board when in an unfolded configuration, the first and second rim configured to support a side wall formed by soft components of the bassinet, the side wall extending upwards from a peripheral region of the bed board to encircle the infant;

a support strut assembly connecting the first rim and the second rim to the bed board; and

a pair of central side mounts, each of the central side mounts connecting to the first rim and the second rim on either side of the bassinet frame assembly; wherein

each of the central side mounts has a first hinge spaced from a second hinge and a locking mechanism to lock the first and second hinges such that the first and second rims are fixed relative to the bed board, and simultaneously unlock both the first and second hinges such that the first rim and the second rim rotate together with the first portion and the second portion of the bed board into a folded configuration.

By designing the bassinet frame assembly such that it does not rely on a single, central hinge, the individual structural components can be smaller and individually less robust. Notwithstanding this, distributing the loads through two hinges on each side of the folding frame assembly still provides an overall structural strength and rigidity that meets the rigorous design standards set for baby bassinets

In some embodiments, each of the central side mounts has mounting formations for releasable inter-engagement with complementary mounting formations attached to or forming part of components of a child stroller, in particular a child stroller comprising a z-foldable frame as disclosed herein.

In a preferred form, each of the locking mechanisms is configured such that they cannot unlock when the central side mounts are inter-engaged with the complementary mounting formations on the stroller.

Optionally, the first and second hinges in each of the central side mounts, have a first and second rim mount for rotation about the first and second hinge axes respectively, each of the first and second rim mounts configured to securely attach to the first and second rims respectively, and having first and second locking abutments respectively, the first and second locking abutments configured to abut the locking mechanism such that the first and second rim mounts are unable to rotate about the first and second hinge axes respectively. In some forms, the locking mechanism is a movable member with a pair of opposed locking surfaces for simultaneous engagement with the first and second locking abutments.

In a particularly preferred form, each of the central side mounts has an inner plate and an outer plate for mounting the first and second rim mounts and the locking plate therebetween. Optionally, each of the central side mounts has a slide button for manually moving the movable member to simultaneously disengage the locking surfaces from the first and second locking abutments.

Preferably, each of the central side mounts has a release button for interaction with the slide button such that depressing the release button is required before the slide button is able to move the movable member. In a particularly preferred form, the slide button is configured to abut the complementary mounting formations on the stroller such that the slide button is not able to move the movable member regardless of whether the release button is depressed, when the bassinet is mounted on the stroller.

Preferably, the bassinet further includes a retractable canopy hinged to the bassinette frame assembly for rotating to an extended position providing weather and sun protection, and retracting to a retracted position, the canopy comprising a supporting frame and a covering of flexible material which folds in a concertina fashion when moving to the retracted position.

Preferably, the canopy incorporates a visor proximate a leading edge wherein the visor moves between a retracted position lying flat against an underside of the flexible material of the canopy, and an extended position extending generally downwards to shade an infant lying in the bassinette from light shining a low incident angle. Preferably, the visor is configured to be selectively adjustable between a range of incrementally stepped positions between the retracted position and the extended position.

### Background: Retractable Canopy for a Bassinet

Bassinets will often have a retractable canopy to shield the infant from the elements. As bassinets also require a handle for lifting and carrying, it is efficient to integrate the canopy together with the handle. Normally, the retractable canopy will have the ability to partially extend or retract and stay at any one of a number of positions between retracted and extended. However, the handle also needs to safely and securely lock in its extended or ‘carrying’ position. This can be achieved by hinging the handle to a pair of lockable hubs on each side of the bassinet. Both hubs have a lock for securing the handle in the extended position. Between the retracted and extended positions, the handle is unlocked and therefore the canopy will sit at intermediate positions. During the early morning or late afternoon, the low angle of the sun will often shine under the canopy onto the baby, even in its extended position. In light of this, it is known to add a sun visor which hangs down from the canopy to shield the baby.

It would be advantageous if this visor were also conveniently adjustable like the canopy, but this requires a second set of inter-engaging formations in each of the hubs, which then become impractically large.

### SUMMARY OF THE INVENTION: RETRACTABLE CANOPY FOR A BASSINET

The retractable canopy described below has been developed with these concerns in mind.

Accordingly, there is provided a retractable canopy for a bassinet, the retractable canopy comprising:

a first hub for attachment to one side of the bassinet;

a second hub for attachment to an opposite side of bassinet;

a handle hingedly connected to the first and second hubs, the handle being movable between a retracted position and an extended position;

a visor rib for supporting a sun visor, the visor rib being hingedly connected to the first hub and the second hub for rotation relative to the handle; wherein the first hub has a handle lock assembly to releasably lock the handle in the extended position; and

the second hub has inter-engaging visor formations defining a plurality of predetermined positions for the visor rib relative to the handle and, inter-engaging handle formations defining a plurality of predetermined positions for the handle between the retracted position and the extended position.

This provides a handle lock that can be incorporated into only one of the side hubs, while the other hub incorporates two sets of inter-engaging formations that define the incrementally stepped positions for the handle, and the visor. Thus each side hub is smaller than if both hubs had a lock for the handle and the mechanism for defining the incremental step locations for both the handle and the visor. By keeping the side hubs small enough, it becomes practical to provide the visor with the incrementally stepped position function rather than a visor that is simply fully deployed from the canopy (and typically held in place by gravity) or otherwise retracted into the canopy, with no intermediate positioning possible.

Preferably, the first hub has a visor hold feature resiliently biased to hold the visor rib in any one of the plurality of predetermined positions while permitting user adjustment of the visor rib between the predetermined positions against the resilient bias.

Advantageously, the first hub can have a first frame attachment piece for connection to the side of a bassinet frame, a first handle mount rotatably connected to the first frame attachment piece for attachment to a first end of the handle, and the handle lock has a movable locking element for locking the first handle mount and the first frame attachment piece when in a locked position, and allowing rotation of the handle mount and the attachment piece when in an unlocked position.

Preferably, the movable locking element is biased to the locked position. Optionally, the handle lock has a release actuator mounted to the first handle mount for rotation therewith, the release actuator being configured for user actuation to move the locking element to the unlocked position against the bias.

Preferably, the retractable canopy can further comprise at least one canopy rib for supporting flexible canopy material extending between the bassinet and the handle.

Preferably, the canopy rib is hingedly attached to the first handle mount.

Advantageously, the second hub can incorporate a second frame attachment piece for attachment to the other side of the bassinet, and a second handle rotatably connected to the second attachment piece, the second handle mount being attached to a second end of the handle, and, the inter-engaging formations in the second hub are a pair of complementary toothed rings with one toothed ring of the pair on the second frame attachment piece and the other toothed ring of the pair on the second handle mount.

Preferably, the first and second hubs have first and second visor mounts respectively for rotatable connection to first and seconds ends of the visor rib respectively, the inter-engaging visor formations being a second pair of complementary toothed rings, one of the second pair being formed on the second visor mount and the other of the second pair being formed on the frame attachment piece.

Advantageously, the second hub has a resilient element to bias the second handle mount away from the second visor mount, wherein the second handle mount and the second visor mount are rotatably connected to each other such that the first and second pair of toothed rings are configured for relative rotation of each toothed ring within each of the pairs, where successive engagement and disengagement of opposing teeth in each of the pairs correspond to the predetermined positions for the handle or the visor.

Preferably, the toothed rings on the second frame attachment piece are arranged coaxially with an aperture for the resilient element extending between the second handle mount and the second visor mount.

### Background: Snack Tray

It can be convenient to provide a snack tray on the stroller to hold a small quantity of snacks for consumption during the journey. However the position of the snack tray on the stroller can sometimes be problematic. For example, if the child is to serve themselves from the snack tray, the tray will typically be attached to the safety bar extending around the seat of the stroller. However with the child strapped into the seat by a 5 point safety harness, there is restricted ability to lean forward and reach into a snack tray if it is an uncomfortable distance away. Furthermore, young children typically have less developed fine motor skills which make an awkwardly positioned snack tray even more frustrating.

Children will typically use a stroller for several years during which time they grow significantly. Therefore a snack tray position that was once conveniently positioned may become non-ergonomic as the child grows.

In some circumstances, the parent or carer may not wish to allow the child access to the snack tray but would rather administer any snacks to the child themselves.

### SUMMARY OF THE INVENTION: SNACK TRAY

With the above issues in mind, a snack tray has been developed for use with a child's stroller and in particular the collapsible stroller frame described herein.

Accordingly, there is provided a snack tray for selective attachment to, and removal from, a child's stroller, the snack tray comprising:

a tray having a least one shallow recess; and

a snap locking formation of resilient material for releasable engagement with at least one frame section of the child's stroller such that the tray is held in a generally horizontal configuration with the shallow recess facing upwards; wherein,

the snap locking formation is configured to selectively engage the frame section in a first orientation and a second orientation, such that in the first orientation, the position of the tray relative to the frame section differs from the position of the tray relative to the frame section in the second orientation.

Preferably, the snap locking formation is rotated 180° in the second orientation relative to the first orientation, and the snap locking formation is secured to the tray at an offset position.

The snack tray is designed to employ the convenience of snap locking attachment to the safety bar of the stroller while off-setting the tray position so the snack tray can be detached, rotated 180° and re-attached to be closer or further from the child. In this way, the tray can be adjusted to a more ergonomic position as the child grows, or an older sibling uses the chair. Furthermore, if the parent or carer decides that the child should not be helping themselves from the snack tray, it can simply be removed from the bumper, and attached to the handle.

Optionally, the tray has a plurality of the shallow recesses and further comprises hinged lids for closing each of the shallow recesses respectively. Preferably, the hinge axis for each lid is configured transverse to the frame section such that the lids do not obstruct the child's access to the shallow recess regardless of whether the snack tray is in the first orientation or the second orientation.

Preferably, the hinged lids and the tray have complementary formations configured to engage for lightly holding each of the lids open for unobstructed access to the recesses.

Preferably, the at least one frame section is provided by a mounting a sleeve fixed about the frame of the stroller, the mounting sleeve having external surface formations for engagement with corresponding formations on the snap locking formation.

Preferably, the snap locking formation has a resilient tongue formed to define a frame recess for receiving the mounting sleeve, the surface formations on the snap locking formation including a rotation anchor extending into the frame recess for engagement with an anchor cavity formed in the surface of the mounting sleeve.

In a further preferred form, the resilient tongue has internal barbed clips for engagement with a surface channel on the mounting sleeve to positively locate the snap locking formation relative to the mounting sleeve during attachment of the snack tray.

Preferably the snap locking formation is detachable from the tray, and may incorporate a tray supporting base, wherein the tray has a mounting spigot for engaging a mounting cavity in the tray supporting base.

The snap locking formation may advantageously comprises locating features for engagement with a side flange extending from one side of the tray such that engagement between the locating features and locating apertures formed in the side flange assist insertion of the mounting spigot into the mounting cavity.

In a preferred form, the tray is formed from a dishwasher safe polymer.

### Background: Adjustable Footrest

A child will often need to use a stroller for several years and during this time, the child will grow significantly. When the child is an infant and unable to sit, it can be carried in the bassinet discussed above. When the child first starts sitting in the stroller, its relatively short legs may barely reach the front edge of the seat. As the child grows, their legs extend further over the front edge which can press into the ankles or calves. For comfort an adjustable foot rest may be used to support their legs more ergonomically at they grow. Initially, the adjustable foot rest will be relatively horizontal and extend forward of the seat. This reduces any additional pressure on the back of the ankles or calves by the front edge of the seat.

As the child grows, the footrest can be adjusted to rotate downwards as their legs hang further over the front of the seat. Unfortunately, the footrest may be adjusted to positions where it is prone to damage (or cause damage) when the stroller is collapsed into its folded configuration. Adjusting the footrest to a position suitable for folding to stroller adds a further step to the folding and unfolding process.

Older children may not need to the footrest at all, and it in fact becomes an inconvenience. At this stage, the footrest may be completely removed. Once removed, the foot rest or its fixing elements risk being lost. Similarly, if the stroller is shared between siblings, the foot rest must be reattached for the younger child.

### Summary: Adjustable Footrest

In view of this, a collapsible stroller has been developed with an adjustable footrest designed with the above problems in mind.

Accordingly, there is provided a collapsible stroller comprising:

a frame assembly selectively configurable in a folded configuration or an unfolded configuration, the frame assembly having

a seat frame with a seat base and

an adjustable footrest hingedly connected to the seat base, the footrest and the seat base each have mutually inter-engaging formations defining a range of predetermined footrests at which the footrest extends at different angles relative the seat base;

wherein the predetermined foot rest positions are all positions at which the foot rest does not impede the foot assembly from moving to the folded configuration.

By restricting the positions that the adjustable footrest can adopt to positions that do not impede the smooth folding or unfolding action of the stroller, there is no risk of damage to the footrest or stroller frame. However the footrest remains adjustable between a range of positions for the comfort of the child.

Preferably the footrest and the seat base together define a selectively lockable hinge assembly providing the mutually inter-engaging formations about a hinge axle at a front edge of the seat base. Preferably the mutually inter-engaging formations are inwardly facing seat splines provided about the hinge axle and inwardly facing footrest splines, both configured for engagement with a movable spline gear for axially displacement about the hinge axle.

Preferably the spline gear has a complementary splines which engage both the seat splines and the foot rest splines when the adjustable footrest is locked in one of the range of predetermined footrest positions, and the spline gear is axially displaceable along the hinge axis to disengage the footrest splines allowing rotation of the footrest about the hinge axis.

Preferably, one of the predetermined footrest positions is a fully retracted position in which the footrest extends beneath the seat base.

Preferably, the seat base provides a pair of outwardly facing hinge axles at either side of the front of the seat base to define the hinge axis, with inwardly facing seat splines provided about both the hinge axles, and a pair of spline gears mounted for axially displacement about both of the hinge axles respectively, with a pair of the inward facing footrest splines provided for engagement with each of the spline gears respectively.

Preferably, the spline gears are each biased into the locked position, and the hinge assembly further comprising a lock release actuator for manually displacing the spline used to the unlocked position against the bias.

Advantageously, the hinge assembly further comprises a full retraction actuator for user actuation together with the lock release actuators in order to move the footrest to the fully retracted position.

### Background: Seat Reclining Mechanism

The seat back on a child's stroller is usually able to recline so that the child sits more upright when awake but may recline to a flatter position when asleep. Often the child will drift off to sleep while sitting upright and the parent will endeavour to gently recline the seat into a better sleeping position for the child. Reclining the seat back must be done carefully so as not to wake the sleeping child. However the seat reclining mechanisms will often involve zips or straps on both sides of the stroller. Reclining one side of the seat back before the other can introduce a twist that is awkward of uncomfortable and risks waking the child.

### SUMMARY OF THE INVENTION: SEAT RECLINING MECHANISM

The above issues have resulted in the development of a child's stroller comprising:

a handle for pushing the stroller;

a seat base and a seat back, the seat back being movable between an upright position and a reclined position;

a pair of frame elements, one frame element of the pair extending from each end of the handle respectively along each side of the seat back;

a first seat reclining strap and a second seat reclining strap for attachment to each of the frame elements respectively to support the seat back, and

a seat clamp; wherein,

the seat clamp has a body to receive the first and second reclining straps from each of the frame elements, the body defining a strap path in which each of the first and second seat reclining straps are folded and brought into an overlapping relationship with each other, the seat clamp further having a moveable clamp element for simultaneously clamping both the first and second seat reclining straps against movement through the body, and configured for manual release of both the first and second seat reclining recliner straps for synchronized movement through the clamp body to adjust the length of each strap between the clamp body and the side frame, to thereby move the seat back between the upright and reclined positions.

the clamp body together with the recliner straps provide an elegantly simple seat reclining mechanism allowing the seat back to recline gently and evenly by manually releasing the seat clamp. Releasing the seat clamp allows both the straps to feed through the clamp body in a synchronised way so that there is no twist or uneven motion as the seat back reclines. This helps to prevent waking a child that that has fallen asleep in the upright position. Successfully transferring the child to a more reclined position without first being roused prolongs the sleep.

Preferably, the seat back has a rigid panel for supporting a padded outer covering and the seat clamp is mounted to the back of the rigid panel. Preferably the clamp body has a first friction surface for engaging the first seat reclining strap and a second friction surface for engaging the second seat reclining strap such that the movable clamp element simultaneously presses both the first and second seat reclining straps onto the first and second friction surfaces respectively.

Preferably, the seat clamp has a manual actuator for moving the movable clamp element away from the first and second friction surfaces to simultaneously release the first and second seat reclining straps for movement through the clamp body.

Advantageously, the movable clamp element and the first and second friction surfaces can be configured such that tensile force on the overlapping first and second seat reclining straps extending from the seat clamp, moves the movable clamp element away from the first and second friction surfaces such that the first and second seat reclining straps are drawn through the seat clamp, and the seat back moves toward the upright position, but tensile pulling applied to the first and/or second seat reclining straps extending individually from the seat clamp remain clamped against movement relative to the body to prevent the seat back moving the reclining position in the absence of manually releasing the movable clamp element.

In this way, the parent is able to lift or recline the seat back using a single hand. Lifting the seat back simply requires pulling on the two overlapping straps extending from the seat clamp while gently reclining the seat back is a matter of carefully using the manual release to move the clamp element. With single handed operation, the parent need not stop pushing the stroller to raise or lower the seat back. This is not only more convenient and time efficient but avoids interrupting the continuous motion of the stroller which may be enough to rouse a child that has just fallen asleep.

In some embodiments, the movable clamp element has a wedge body with a first strap wedge surface arranged in angled relation to a second strap wedge surface and the first and second strap friction surfaces are arranged in a corresponding angle such that the first and second strap wedge surfaces simultaneously urge the first and second seat reclining straps onto the first and second strap friction surfaces respectively.

Preferably, the manual actuator has a retraction slide surface for engaging the wedge body to move the movable clamp against the resilient bias.

Preferably, the manual actuator has a lift lever hingedly mounted to the clamp body for mechanical advantage when displacing the movable clamp against the bias.

Advantageously, the first and second seat reclining straps extend from the seat clamp at generally right angles to the overlapping first and second seat reclining straps.

Illustrative embodiments of the present invention will now be described by way of example only and with reference to the accompanying drawings

### BRIEF DESCRIPTION OF THE DRAWINGS

FIG. 1 is a front perspective of the collapsible stroller frame assembly according to the present invention;

FIG. 2 is a partially exploded perspective of the collapsible stroller frame assembly shown in FIG. 1 with a seat safety bar and retractible hood frame;

FIG. 3 is a partially exploded perspective of the left side (as viewed by the person pushing the stroller) of the handle frame;

FIGS. 4 to 6 are schematic partial perspectives of the upper hinge unlocking;

FIG. 7 is a schematic illustration of the lower hinge unlocking;

FIG. 8 is a partial explode perspective of the left side of the seat frame;

FIG. 9 is an exploded perspective of the hinge discs from the upper hinge shown in isolation;

FIG. 10 is a perspective of the hinge disc for attachment to the lower end of the handle frame shown in FIG. 3;

FIG. 11 is an exploded perspective of the hinge discs of the lower hinge shown in isolation such that the interior of the front wheel frame hinge disc is revealed;

FIG. 12 is an exploded perspective of the hinge discs of the lower hinge shown in isolation such that the interior of the rear wheel frame assembly is revealed;

FIG. 13 is a partial perspective showing the seat frame with seat and footrest together the folding seat back;

FIG. 14 is an exploded perspective of the safety bar and retractable hood frame;

FIG. 15 shows a rear perspective view of the seat back;

FIGS. 16A to 16D show side elevations of the stroller frame assembly as it collapses from an unfolded configuration to a folded configuration;

FIG. 17 is a perspective view of a pair of bassinet adaptors for snap locking to the seat frame for the stroller to carry a bassinet;

FIG. 18 is a plan view of the bassinet adaptors of FIG. 17;

FIG. 19 is the frame assembly for a foldable bassinet;

FIG. 20 is an enlarged perspective of one of the central mounting joints for the bassinet frame assembly shown in FIG. 19;

FIG. 21 is an exploded perspective of the central mounting joint shown in FIG. 20;

FIG. 22 is an exploded perspective of the inner plate and the latch assembly of the central mounting joint shown in FIG. 21;

FIG. 23 an enlarged perspective of the wedge side button used in the central mounting joint shown in FIG. 21.

FIG. 24 is a perspective view of the bassinet with canopy and sun visor both in an extended position;

FIG. 25 is a perspective of the bassinet with the canopy in the extended position and sun visor in the retracted position;

FIG. 26 is a perspective of the retractable bassinet canopy frame assembly shown in isolation;

FIG. 27 is an exploded perspective of the retractable bassinet frame assembly shown in FIG. 26;

FIG. 28 is an enlarged exploded perspective showing the inward slide of the first hub of the retractable canopy frame assembly;

FIG. 29 is an enlarged exploded perspective showing the outward facing surfaces of the first hub;

FIG. 30 is an enlarged exploded perspective of the outward facing surfaces of the second hub of the retractable bassinet canopy frame assembly;

FIG. 31 is an enlarged exploded perspective showing the inward facing surfaces of the second hub;

FIG. 32 is a perspective of the seat and adjustable foot rest in isolation;

FIG. 33 is a partially exploded perspective of the seat base and the adjustable foot rest shown in FIG. 32;

FIG. 34 is an enlarged partial perspective of the seat base showing the right hand side tubular foot rest axle housing;

FIG. 35 shows the spline gear hinge axle 3 used in the hinge axle of the adjustable foot rest;

FIG. 36 is an exploded partial perspective of one of the foot rest rim mounts and its associated lock release button;

FIG. 37 is an enlarged perspective of the retraction lock button and slide plate used to move the adjustable foot rest to its fully retracted position;

FIG. 38 is a perspective of the seat clamp shown in isolation together with a schematic representation of the seat reclining straps folded in the manner in which they are configured within the strap path through the seat clamp;

FIG. 39 is an exploded perspective of the seat clamp showing its outward facing surfaces;

FIG. 40 is an exploded perspective of the seat clamp showing its inward facing surfaces;

FIG. 41 is a perspective of the seat clamp attached to the upper panel of the seat back with reclining straps being drawn through the clamp by the lifting loop to move the seat back to an upright position;

FIG. 42 is a perspective of the upper and lower panels of the seat back with the seat clamp mounting plate attached to the inner surface of the upper panel;

FIG. 43 is a bottom perspective view of a snack tray for use with a collapsible child stroller;

FIG. 44 is a top perspective view of the snack tray shown in FIG. 43;

FIG. 45 is an exploded perspective of a snack tray shown in FIG. 43;

FIG. 46 is a partial enlarged perspective of a snack tray showing the resilient lid hold feature;

FIG. 47 is a partial enlarged perspective of a hinged lid showing the hinge axle and lid hold detents;

FIG. 48 is a top perspective of a snap locking formation to attach the snack tray to the stroller;

FIG. 49 is a bottom perspective of the snap locking formation shown in FIG. 48;

FIG. 50 is a sleeve configured for detachable engagement with the snap locking formation of FIGS. 48 and 49.

### DETAILED DESCRIPTION OF THE PREFERRED EMBODIMENTS

### Z-Folding Frame Assembly

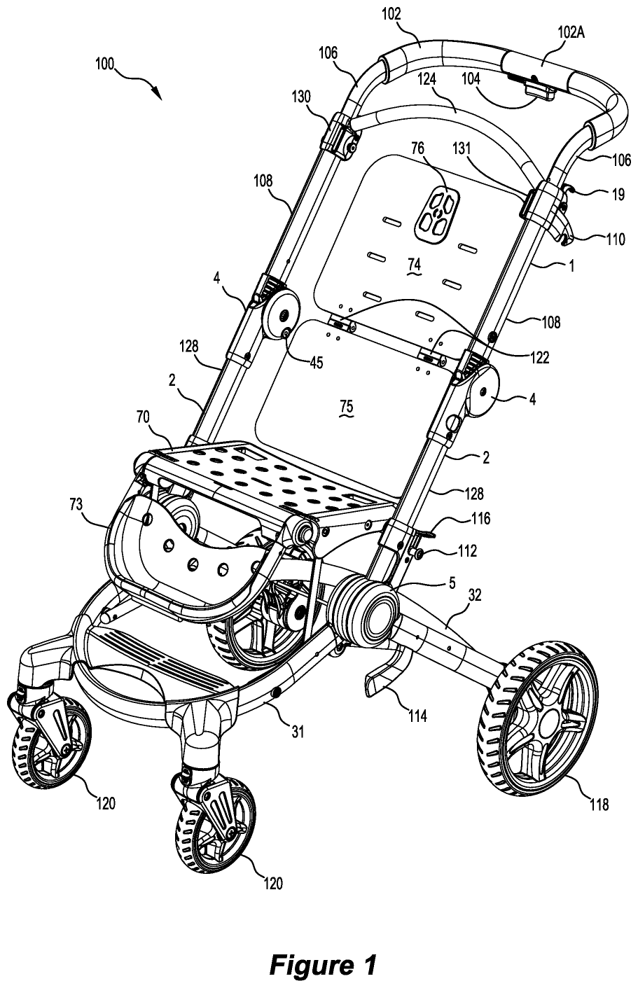

Referring to FIGS. 1 to 15, a frame assembly for a collapsible stroller according to the invention is shown.

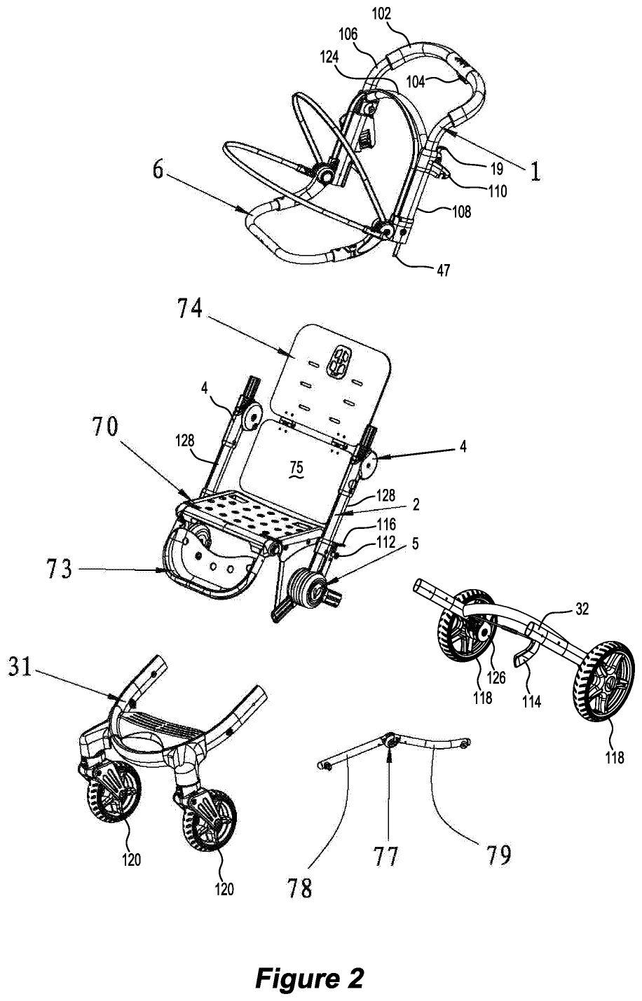

FIGS. 1 and 2 show a perspective and exploded perspective of the stroller frame assembly respectively. The soft components such as the fabric coverings and padding for the seat and seat back have been removed for clarity. FIG. 1 has also removed the front safety bar 6 and retractable hood frame shown in FIG. 2 in the interests of clarity.

The stroller frame assembly 100 has four sub-frames:

handle frame 1;

seat frame 2;

front wheel frame 31; and

rear wheel frame 32.

Hinging these sub-frames together is an upper hinge 4 and a lower hinge 5.

The front wheel frame 31 extends forward from the lower hinge 5 and has a front wheel assembly 120 in the form of a pair of spaced castors. These castors are spring mounted to give some suspension for enhanced ride comfort.

Rear wheel frame 32 supports a rear wheel assembly in the form of two spaced apart wheels 118. Rear wheels 118 can be locked using a foot brake 126 with a pedal actuator of the type known in this field. Extending between the front wheel frame 31 and the rear wheel frame 32 is hinged cross-bracing 77, 78 and 79. Straight section 78 is hinged to the front wheel frame 31 and curved section 79 is hinged to the rear wheel frame 32. Sections 78 and 79 are connected at hinge 77. The curved section 79 is curved or bent so that the hinge 77 bends towards the lower hinge 5 (ie. upwards as shown in FIG. 2). To ensure the cross-bracing 78 and 79 hinge upwards, the hinge 77 is spring biased and has restricted rotation to prevent folding downwards.

The seat frame 2 supports the seat 70 together with an adjustable footrest 73 hinged at the front edge of the seat 70. The seat back is provided by an upper panel 74 connected to a lower panel 75 along hinge connection 122. The hinge connection 122 substantially aligns with the axis of the upper hinge 4 so that the seat back folds together with the rest of the frame assembly.

The upper hinge 4 and the lower hinge 5 are spaced apart by a pair of tubular seat frame members 128. Within the tubular frame members 128 is a mechanical link operatively connecting the upper hinge 4 to the lower hinge 5 (described in more detail below).

The handle frame 1 includes a handle 102 covered with a grip. The handle 102 extends between two spaced apart inner handle frame elements 106. The inner handle frame elements 106 are telescopically received within a respective pair of outer handle frame elements 108. On the underside of the handle 102 is a button 104 which allows the handle height to be adjusted for better ergonomics.

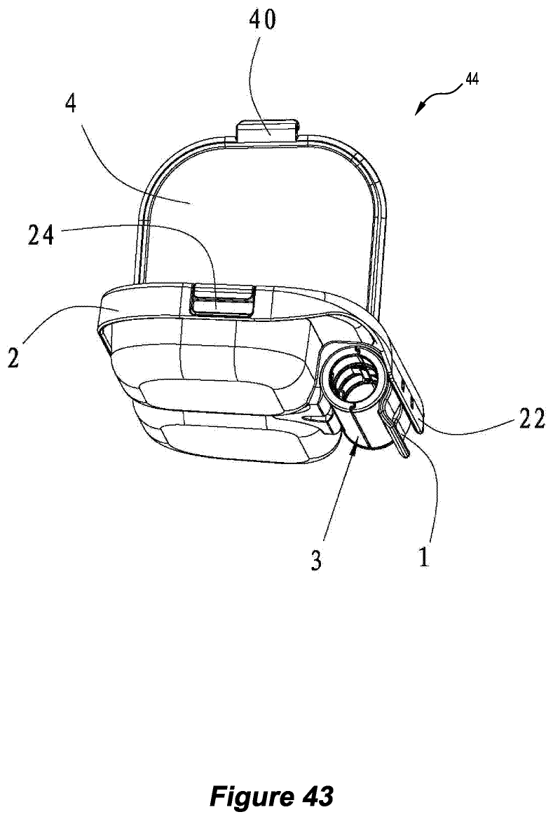

A snap on cover 102a fits over the central part of the handle 102 above the button 104. The snap on cover 102a can be detached and replaced with a snap on snack tray described below with reference to FIGS. 43 to 50.

At the upper end of the outer handle frame elements 108 is a curved cross-bracing 124 to provide structural rigidity and a smoother telescoping action for the handle frame 1.

The curved cross-bracing 124 is mounted to sleeves 130 and 131 fixed to the top of the outer handle frame elements 108 respectively. The sleeve 131 differs from the opposing sleeve 130 in that it has an integral hook 110 forming part of the latch that holds the stroller frame in its folded configuration (described in more detail below).

The sleeves 130 and 131 also hold release actuators in the form of retractable triggers 19. These triggers initiate the process of unlocking the upper hinge 4.

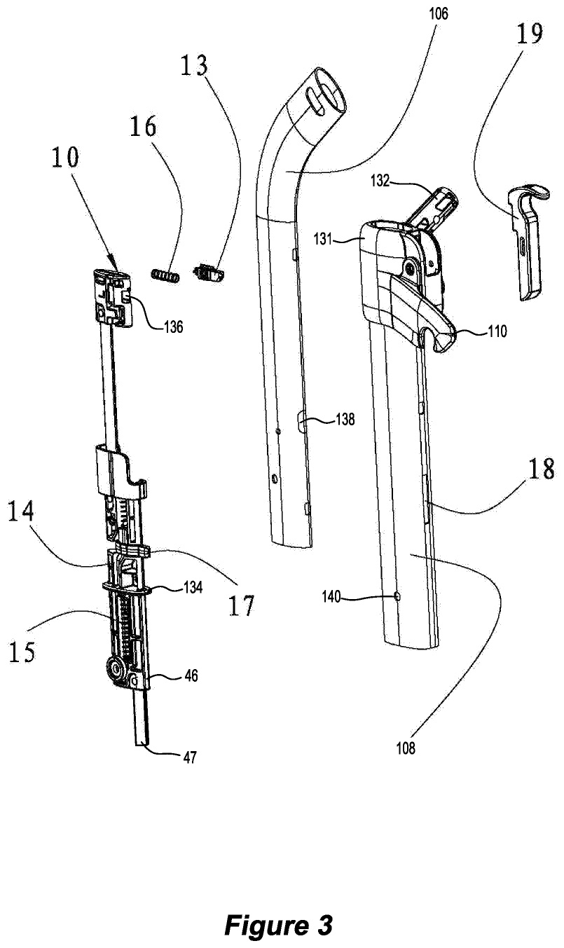

Referring to FIG. 3, the telescoping frame elements 106 and 108 of the handle frame are shown together with the manually actuated release assembly 10, 13, 16 and 19.

As discussed above, the height of the handle 102 is adjustable by sliding the inner handle frame members 106 relative to the outer handle frame members 108. User actuation of the button 104 on the underside of the handle 102 allows the handle height to be adjusted between set positions. With the handle in its lowest adjustable height position, the user can simultaneously pull both the triggers 19 upwards. This draws the retractable snib 13 out of the aperture 136 against the bias of spring 16. The internal hinge actuator 10 is mounted within the inner handle frame elements 106 and outer handle frame elements 108. The lower end of the inner handle frame element 106 pushes against abutment 134 of the hinge actuator 10, while the sliding guide 17 partially protrudes from the hole 138 to slide within the slot 18 of the outer handle frame element 108.

The actuator rod bracket 46 holds an actuator rod 47 so that its lower end extends from the outer handle frame element 108, and into the upper hinge 4. A pin (not shown) extending through the outer handle frame element 108 at the hole 140 abuts against the lower end of the return spring 15 held within the actuator rod bracket 46.

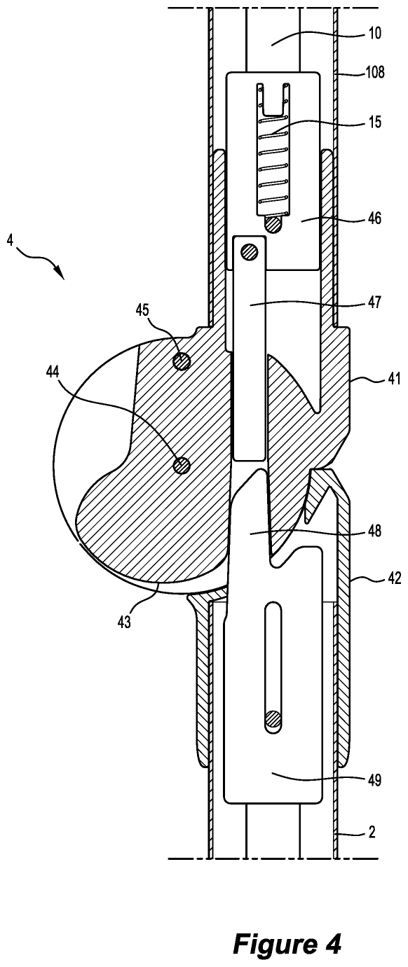

Unlocking the upper hinge 4 will now be described with particular reference to the schematic section views shown in FIGS. 4, 5 and 6. Once the snib 13 has been retracted by the trigger 19, the user can push the hinge actuator 10 downwards within the outer handle frame elements 108 against the bias of return spring 15.

Telescoping the inner handle frame elements 106 into the outer handle frame elements 108 pushes the hinge actuator 10 downwards against the return bias of the spring 15 pushing against the pin 151. At the lower end of each of the outer handle frame elements 108, is a handle hinge disc 41. The handle hinge disc 41 fits within a slot defined by the seat hinge disc 42 fixed to the upper end of the tubular seat frame members 128.

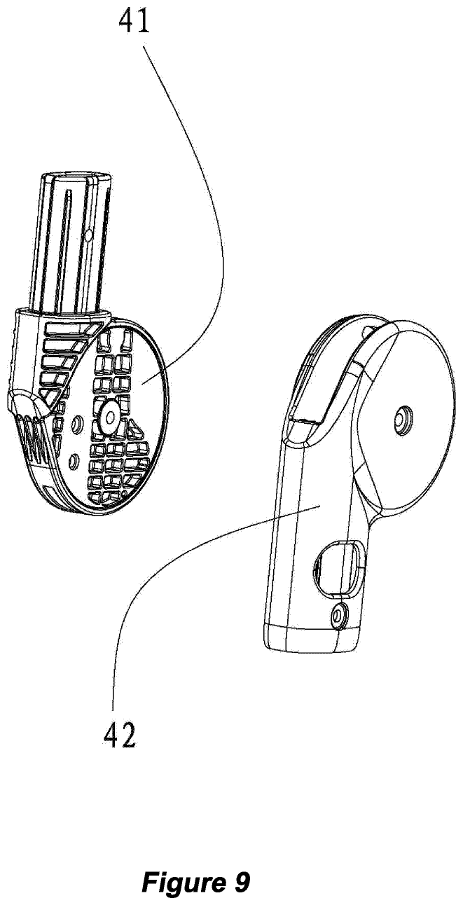

As best shown in FIG. 9, the handle hinge disc 41 fits into the slot 421 of the seat hinge disc 42. One side of the seat hinge disc has a guide slot 422 for engagement with a guide pin 45 (see FIGS. 4, 5, 6) to stabilise and assist the hinging action. As shown in FIG. 4 the handle hinge disc 41 and the seat hinge disc 42 together define a hinge passage 412 when the handle frame 1 and seat frame 2 are in the unfolded configuration. First hinge locking rod 48 extends from the upper end of the tubular seat frame members 128 into the hinge passage 412 such that the first hinge 4 remains locked.

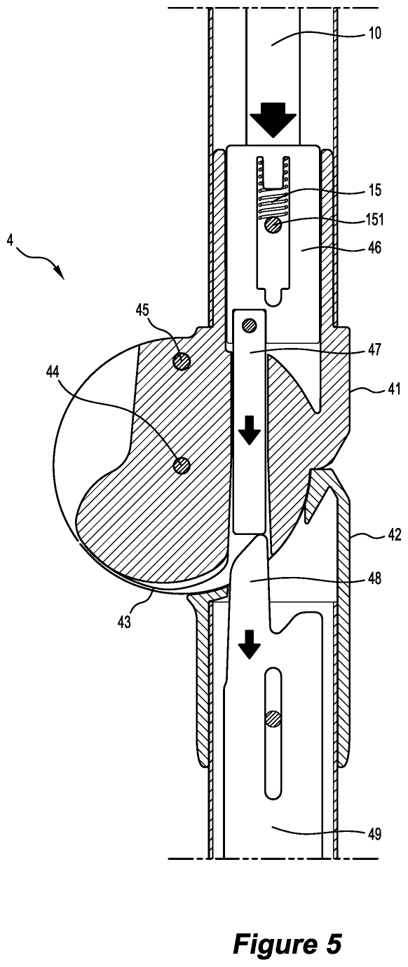

As shown in FIG. 5, telescoping the inner handle frame elements into the outer handle frame elements 108 pushes the hinge actuator 10 and therefore the hinge actuator rod 47 downwards through the hinge passage 412 against the bias of the return spring 15.

In turn, the hinge actuator rod 47 pushes the locking rod 49 towards the lower end of the hinge passage 412.

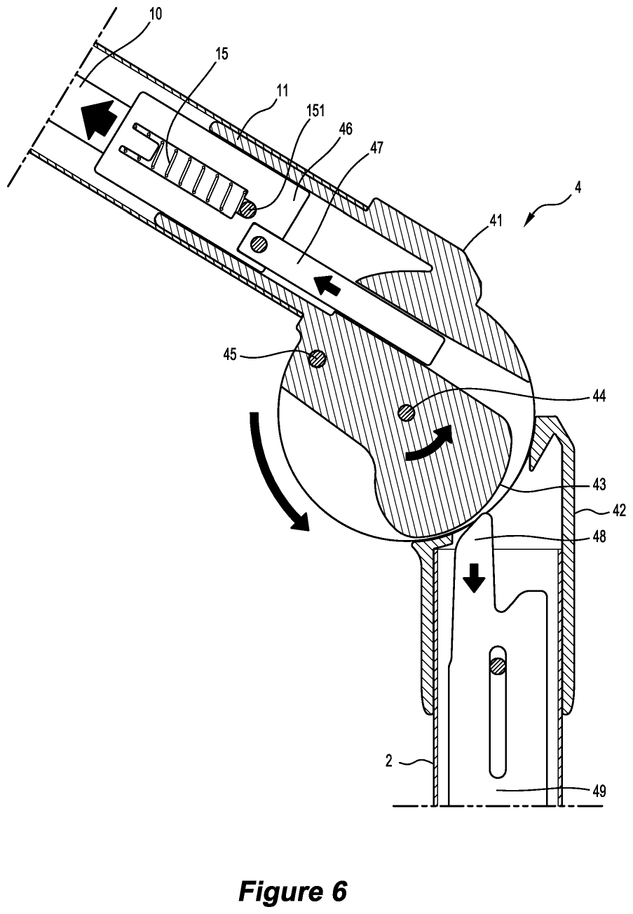

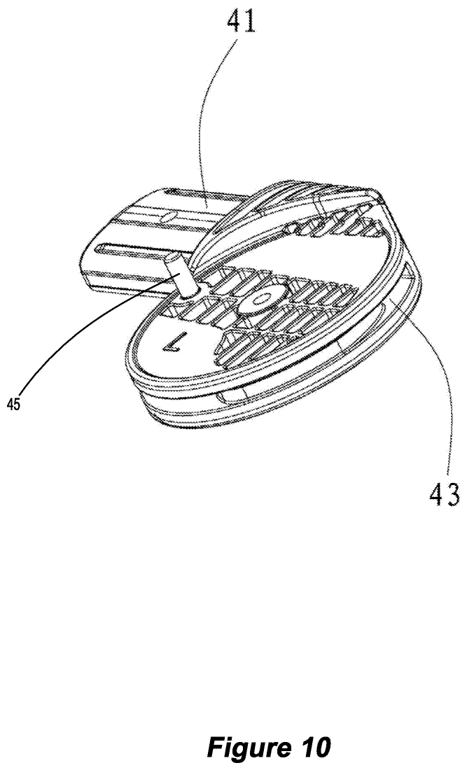

As best shown in FIG. 6, the curved profile of the upper end of the locking rod 49 interacts with a camming surface 43 formed in the handle hinge disc 41. The angular orientation of the curved end of the locking rod 49 and the camming surface 43 allows relative rotation of the handle disc 41 and the seat hinge disc 42 about the first hinge axle 44. At this point, the first hinge has been unlocked but the lower hinge 5 remains locked. However continued rotation of the handle hinge disc 41 relative to the seat hinge disc 42 forces the locking rod 48 further downwards through the camming action of the camming surface 43. In the meantime, the user can allow the hinge actuator rod 47 to retract back into the hinge passage 412 under the bias and the return spring 15. As best shown in FIG. 10, the camming surface 43 continues to cam mechanical link 20 downwards until the upper end of the locking rod 48 reaches the end 431 of the cam surface 43. At this point, the handle frame is approximately horizontal to the ground (the wheel base of the stroller) before initiation of the next stage of the folding process by the user (discussed below).

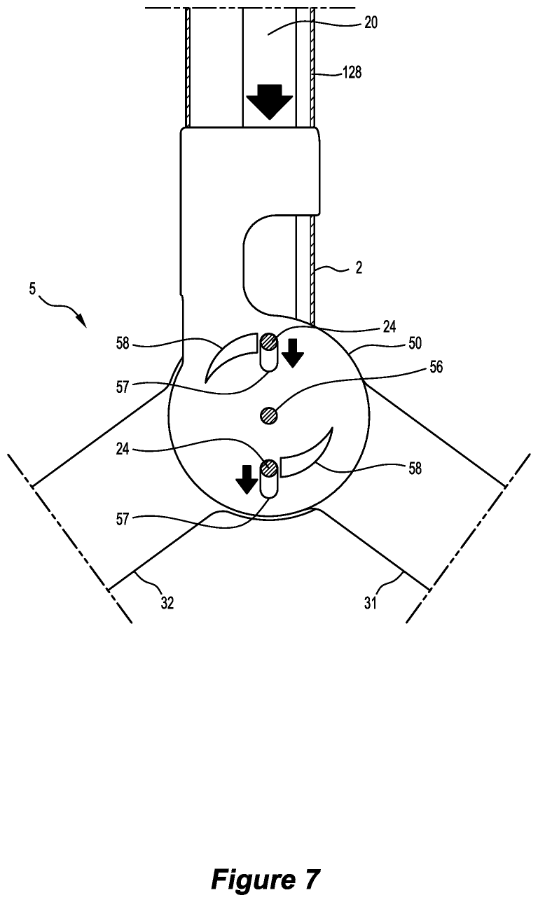

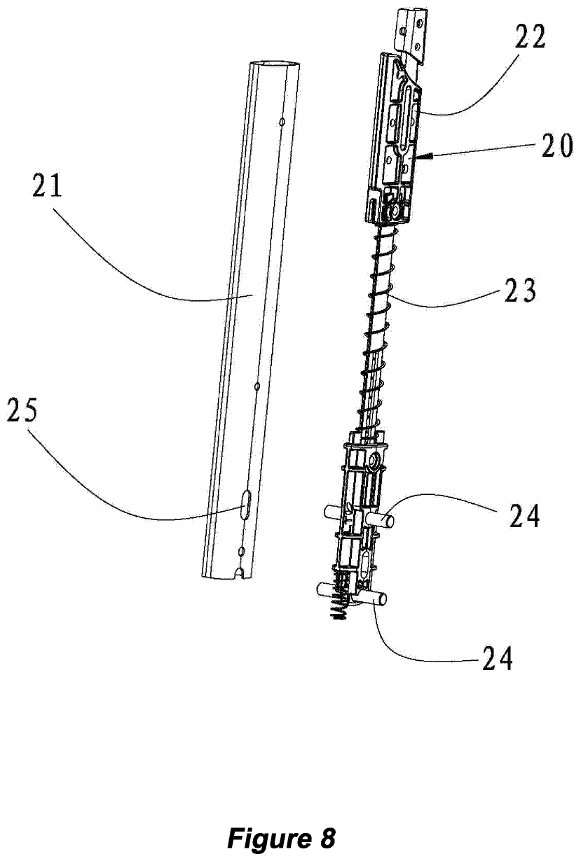

Unlocking the lower hinge 5 is described with reference to FIGS. 7, 8, 11 and 12. As best shown in FIG. 8, the tubular frame member 128 houses the mechanical link 20 extending from its upper end to its lower end. At its upper end, the first hinge locking rod 48 rigidly connects to a transition bracket with a guide slot 205 for receiving a pin 201 to assist movement within the seat frame member 128.

The mechanical link is biased upwards relative to the tubular seat frame member 128 by the return spring 23 which compresses against a pin 203 extending through the hole 207. At the lower end of the mechanical link 20 are a pair of spaced apart retaining posts extending from both sides of a bottom bracket 209. The upper retaining post 24 extends through a post guide slot while a pin 211 slides within the lower bracket guide slot 203 when the lower hinge locks and unlocks.

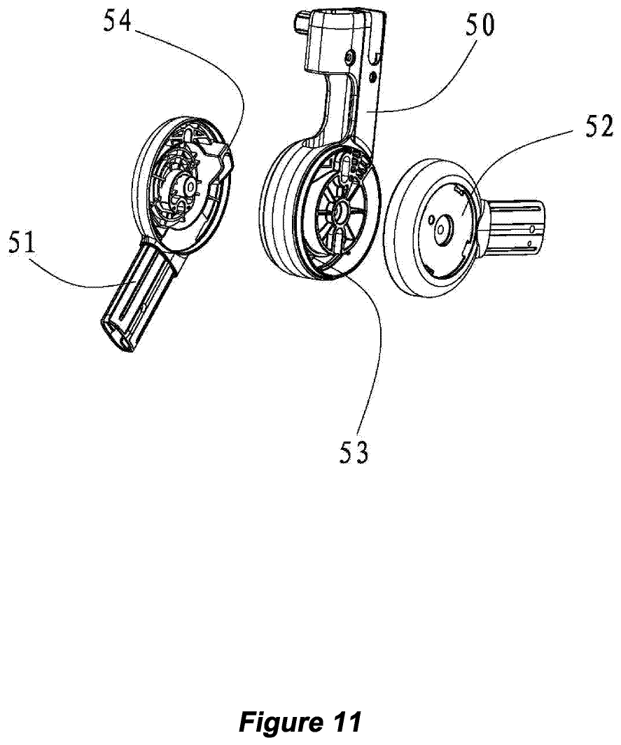

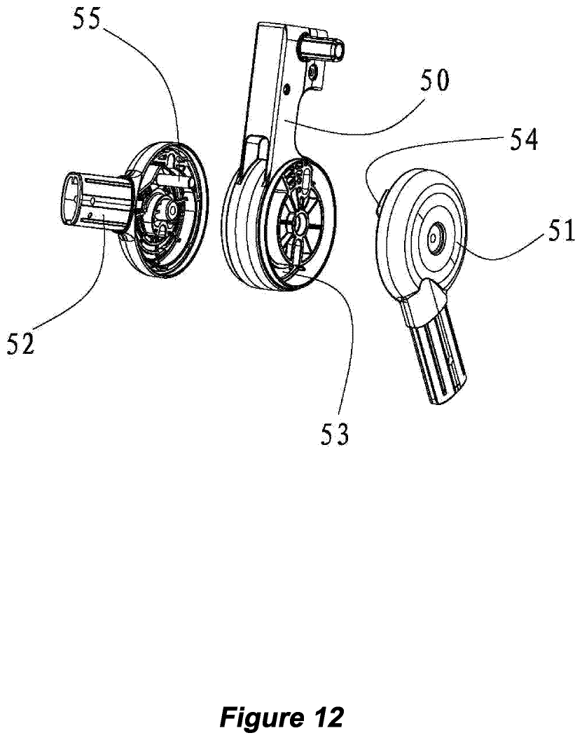

As schematically shown in FIG. 7, when the mechanical link 20 is pushed downwards, the retaining posts 24 move downwards relative to the tubular seat frame 128 and central hinge disc 50 fixed to the lower end of the seat frame member 128. As best shown in FIGS. 11 and 12, on either side of the central hinge disc 50 is the front wheel frame disc 51 and the rear wheel frame disc 52. The front frame disc 51 and rear front disc 52 are connected via the lower hinge axle 46 as well as a stabiliser pin 55 that extends through an arcuate slot 53. The central hinge disc 50 houses the lower bracket 209 in central recess 501 so that the retaining posts 24 extend through post-slide slots 57 formed in both the front frame disc and the rear frame disc.

When the lower hinge 5 is locked, the retaining posts 24 abut corresponding abutment faces 54 formed in the front and rear frame discs 51 and 52 respectively. Pushing the mechanical link 20 downwards disengages the retaining posts 24 from their respective abutment surfaces 54 so that the lower hinge 5 unlocks and front and rear frame discs are free to rotate relative to the central hinge disc 50.

When the stroller is moving from its folded to unfolded configuration, the front and rear frame discs 51 and 52 respectively have ramped guide surfaces 58 for sliding engagement with the retaining posts 24. The ramped guide surfaces 58 cam the retaining posts downwards until the predetermined unfolded configuration is reached and the retaining posts 24 snap upwards under the bias of the return spring 23 to once again engage the abutment surfaces 54, thereby locking the lower hinge 5.

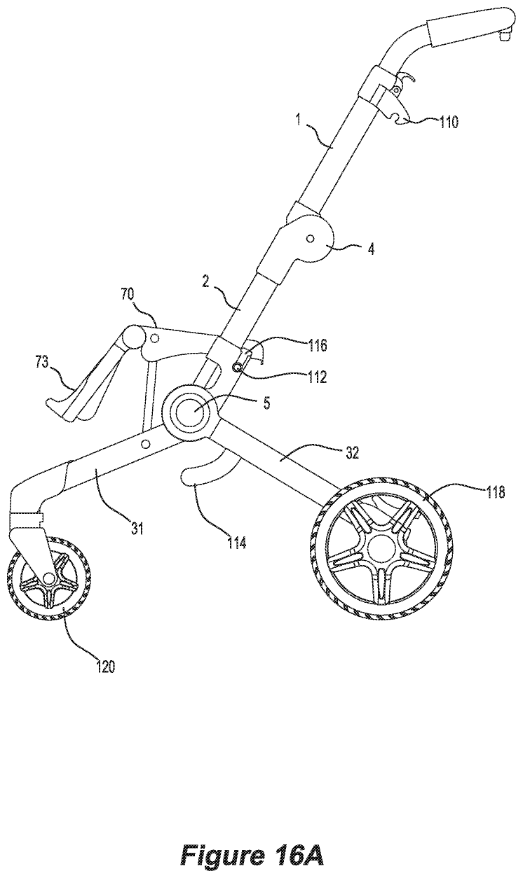

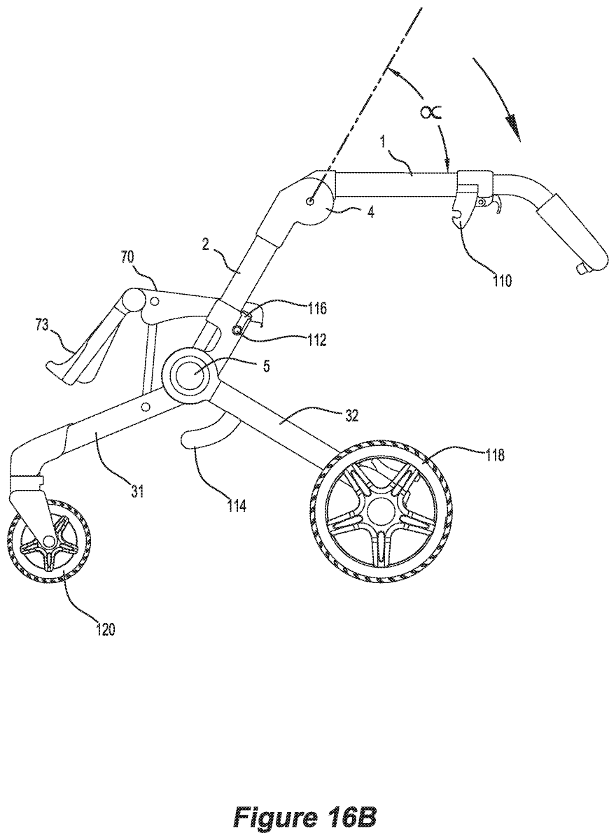

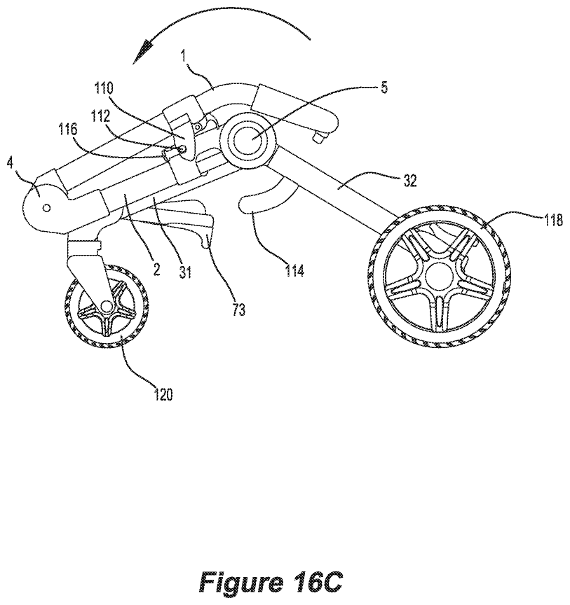

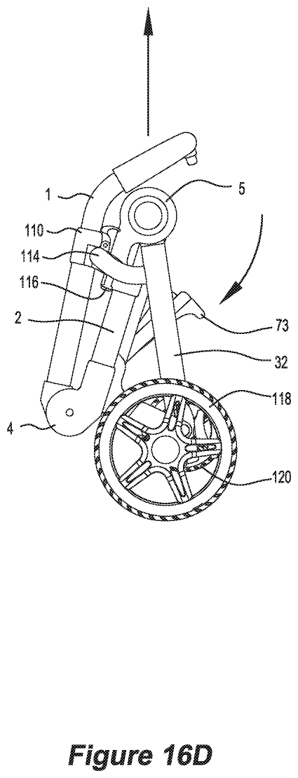

The latch assembly for latching the stroller frame assembly 100 in the folded configuration will now be described with particular reference to the main stages of the folding process shown in FIGS. 16A to 16D. FIG. 16A shows the stroller in its unfolded configuration and the separate components the latch assembly disengage from each other. The latch assembly consists of a hook 110 attached to the handle frame 1, a spigot 112 extending from the side of the seat frame 2 and a hasp 114 extending from the rear wheel frame 32.

### Latch Assembly

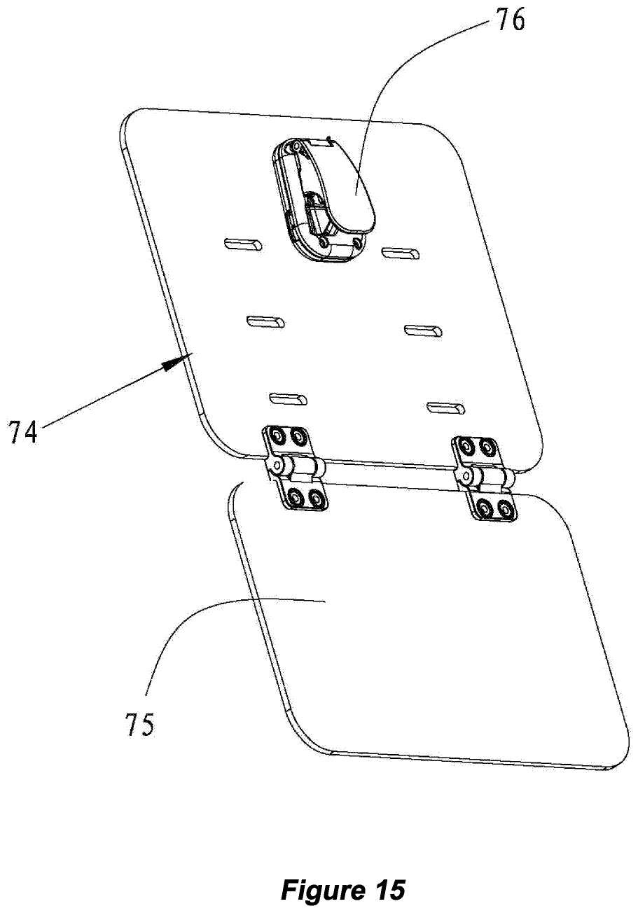

FIG. 16B shows the first stage of the folding process in which the handle frame 1 is rotated about the upper hinge 4 by a predetermined angle α as described in detail above. As discussed above in relation to FIG. 9, the guide pin 45 begins moving along the guide slot 422 as the handle frame 1 rotates about the upper hinge 4. Referring briefly to FIGS. 1 and 15, a strap (not shown) is attached to the outer ends of the guide pin 45 which extends behind the lower panel 75 of the seat back. As the guide pins 45 on each of the upper hinges 4 begin to rotate with the handle frame 1, the strap (not shown) pulls the lower panel 75 of the seat back forwards to begin the relative rotation of the upper and lower panels about the hinge connection 122. This ensures that the upper and lower panels 74 and 75 begin, and therefore continue to fold in the correct direction.

At the predetermined angle α between the handle frame 1 and the seat frame 2, the lower hinge 5 unlocks. This allows the user to continue folding the handle frame 1 towards the seat frame 2 while the seat frame rotates about the lower hinge 5 towards the front wheel frame 31. The hinged connectors between the seat 70, the seat frame 2 and the front wheel frame 31, ensure the seat 70 is generally parallel to the seat frame 2 and front wheel frame 21 in the folded configuration.

FIG. 16C shows the handle frame 1 and the seat frame 2 both overlaid on the front wheel frame 31. The hook 110 on the handle frame 1 has a leading surface that acts as a cam against the spigot 112 which is slidably mounted on the seat frame 2 and held in a frame secured position by a spring (not shown). The leading surface of the hook 110 displaces the spigot 112 against the force of the spring. When the spigot reaches the entrance to the hook, it is resiliently biased into engagement with the hook. This effectively secures the handle frame 1 to the seat frame 2.

Engaging the hook 110 with the spigot 112 is the cue for the user to lift the frame assembly upwards by the handle. This draws the lower hinge 5 upwards so that the front wheel frame 31 and the rear wheel frame 32 are drawn together by gravity. The hasp 114 extending from the rear wheel frame 32 rotates into automatic engagement with the top of the spigot 112 via an inwardly facing barbed formation. This secures the rear wheel frame 32 to the seat frame 2. The front wheel frame 32 is trapped between the rear wheel frame 32 and the seat frame 2 so that it is also secured in the folded configuration.

To unfold the stroller fame assembly, the user holds the handle so that the frame members are in a generally vertical configuration as shown in FIG. 16D. Sliding the spigot 112 to its frame release position and temporarily holding it there using the tab 116 simultaneously releases the spigot 112 from the hasp 114 and the hook 110. Lifting the handle 1 rotates the seat frame 2 about the lower hinge 4 until the handle frame 1 and seat frame 2 align and automatically lock the upper hinge 4. Referring back to FIG. 8, the lower bracket 209 in the mechanical link 20 has a forward angle bias spring 503 that urges the front wheel frame 31 to angle itself slightly forward of the seat frame 2 when suspended beneath the lower hinge 5. This small forward angle on the front wheel frame allows the user to lower the frame assembly back to the ground so that the front wheel frame naturally rotates forwards until it is locked in position by the lower hinge 5. Similarly, the user can continue to lower the handle such that the rear wheel frame 32 rotates rear-wardly until locked in position by the lower hinge 5.

### Safety Bar and Retractable Hood Frame

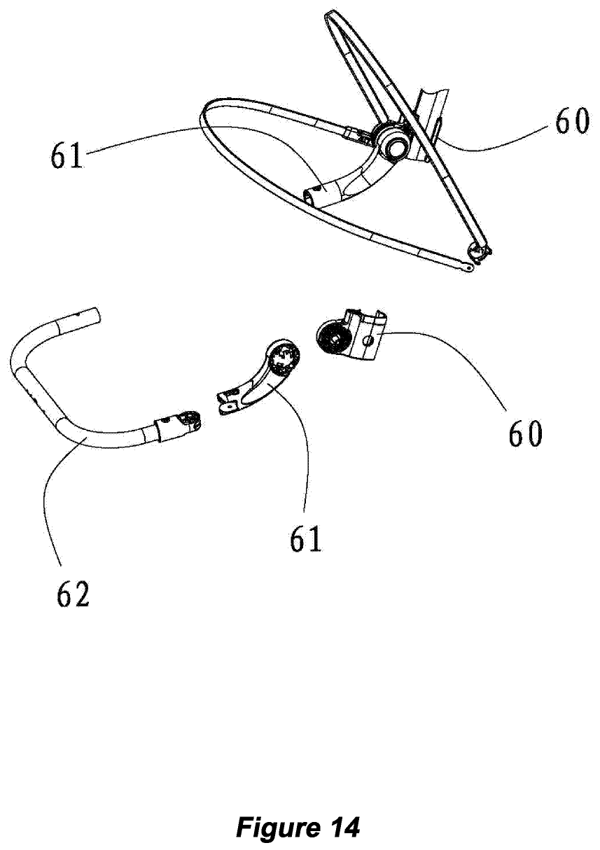

FIG. 14 is an exploded perspective of the combined safety bar and retractable hood frame for the stroller. Hood frame hinge mounts 60 attached to each side of the handle frame 1. The hood frame hinge mounts 60 provide a hinged connection point for the bowed support ribs 63 feeding through the fabric of the retractable hood (not shown). The safety bar 62 also hingedly attaches to the hood frame hinge mounts 60 via the safety bar connectors 61. The hood frame hinge mounts 60 provide a common hinge axis for the retractable hood support ribs 63 and the safety bar connectors 61. However the safety bar connectors 61 are lockable in an extended position (as shown in FIG. 14) or a retracted position in which the safety bar is concealed beneath the hood. To shift the safety bar 62 between the extended and retracted positions, actuation buttons 65 on both the hood frame hinge mounts 60 are depressed to allow rotation of the safety bar connectors 61.

Combining the hinge mount for the safety bar 62 and the hood support ribs 63 allows the safety bar to easily retract beneath the hood thereby taking the safety bar out of service without removing it from the stroller. Removing components from the stroller risks misplacing those components and the attachment/detachment process can be generally inconvenient and more time consuming than simply rotating the safety bar 62 such that it is concealed beneath the hood.

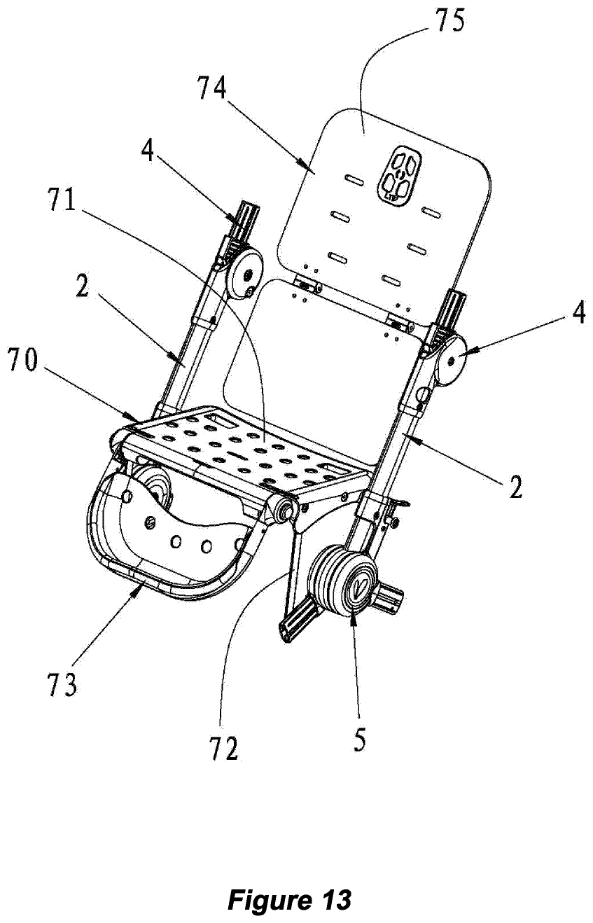

By retracting the safety bar 62 out of service, it does not form an obstruction when placing the toddler in the stroller or lifting them out of the seat. With the safety bar in the extended position it may be necessary to lift the toddler into the stroller seat and thread their legs beneath the safety bar 62. Similarly, removing the toddler from the stroller requires their legs to be threaded back through the gap between the safety bar 62 and the seat base 71 (see FIG. 13). Moving the safety bar 62 to the retracted position takes it out of service while it remains connected to the rest of the stroller and allows unobstructed access to the child held in the seat by a seat harness.

For safety reasons, the hood frame hinge mounts 60 are configured such that hood support ribs 63 are wider than the safety bar connectors 61 (and the safety bar 62) to avoid an finger pinch points.

Despite having the option of retracting the safety bar 62 out of service beneath the hood, detachable connectors 64 are provided at either end of the safety bar the user wish to have it completely detached.

### Foldable Bassinet

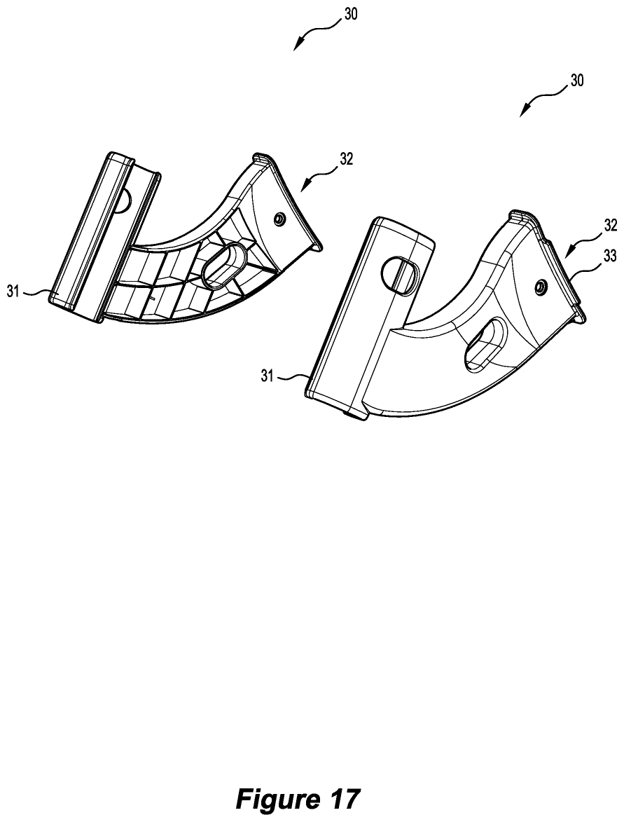

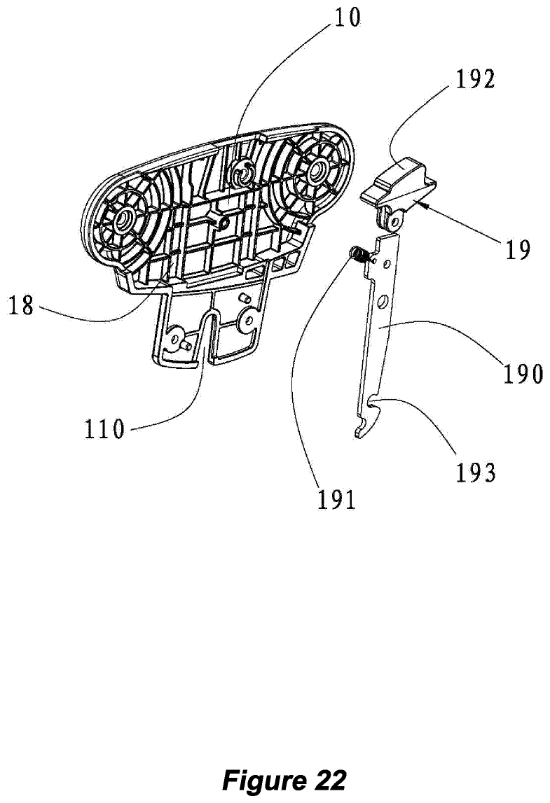

Newborns and young babies are not yet able to sit. These infants require a bassinet in which they lie while travelling the stroller. While bassinets are not as large as strollers, they still occupy a substantial amount of space and can be inconvenient to store or transport in a vehicle. In light of this, a folded bassinet has been developed which now be described with reference to FIGS. 17 to 23.

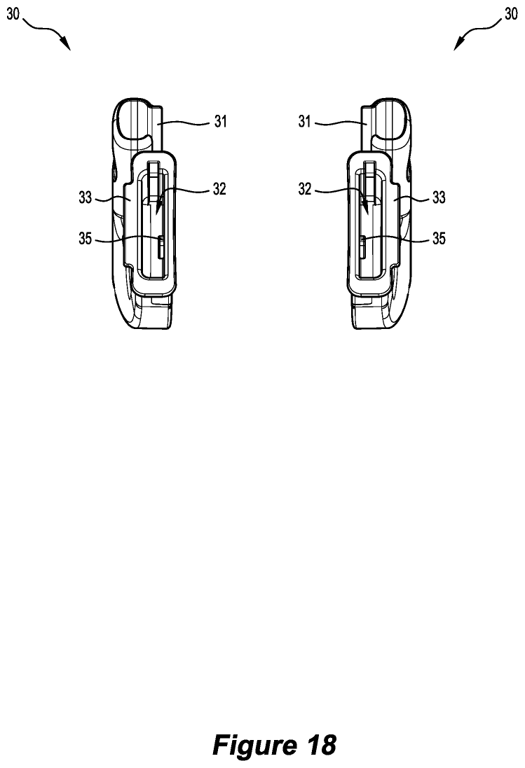

To carry the bassinet on the stroller, a pair of bassinet adaptors 30 are detachably mounted to the seat frame 2 of the stroller 100 (see FIG. 1). As shown in FIGS. 17 and 18, the bassinet adaptors 30 each have a snap locking mount 31 configured to detachably grip the exterior of the seat frame tubing 128 so that the mounting recesses 32 face upwards.

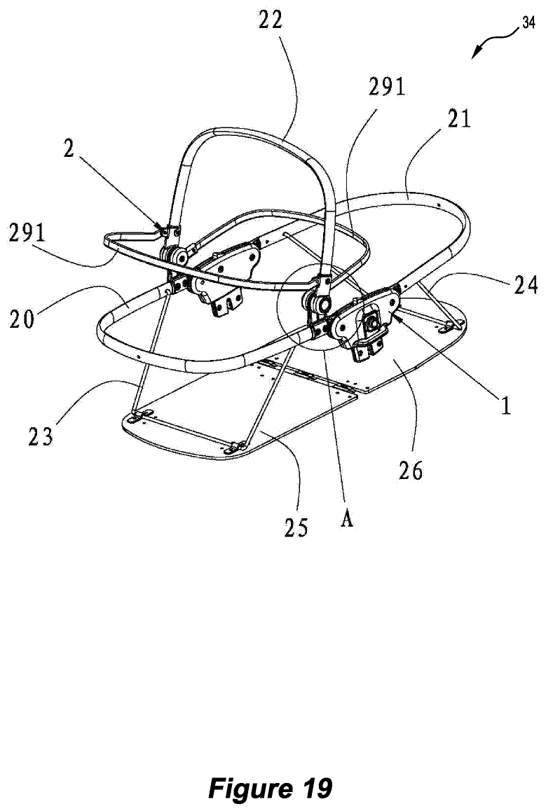

The folding bassinet frame assembly is shown without any of its soft components in FIG. 19. The folding bassinet frame assembly has a bed board provided by first and second portions (25 and 26) hinged together to provide a generally flat supporting surface for the baby when the bassinet is in the unfolded configuration. Above the bed board (25 and 26) are first and second rims (20 and 21) which are spaced from the periphery of the bed board to support the top of a sidewall provided by the soft components covering the bassinet frame assembly. Between the first and second rims (20 and 21), and the bed board (25 and 26) are support strut assemblies (23 and 24). On either side of the bassinet frame assembly 34 are central side mounts 1 which connect to the first and second rims (20 and 21).

Above the bassinet is a retractable hood frame 291 together with a handle frame 2 for attachment to each side of the first rim 20 adjacent the central side mounts 1. The retractable hood and handle are described in greater detail below.

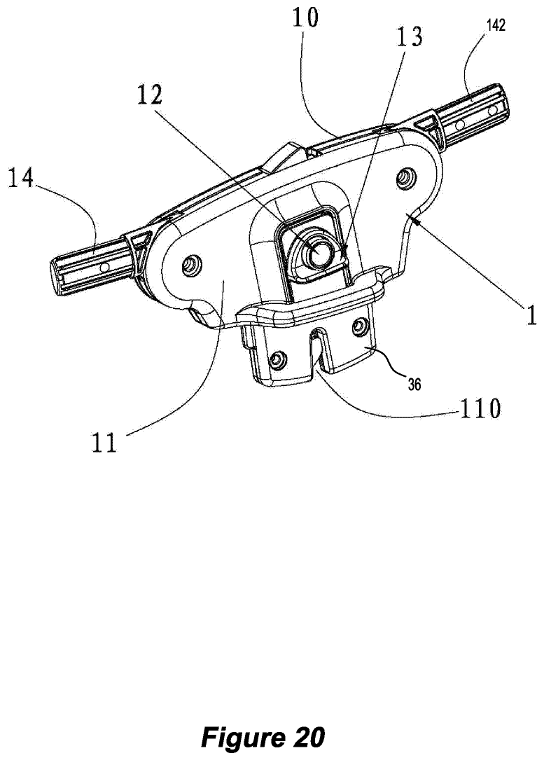

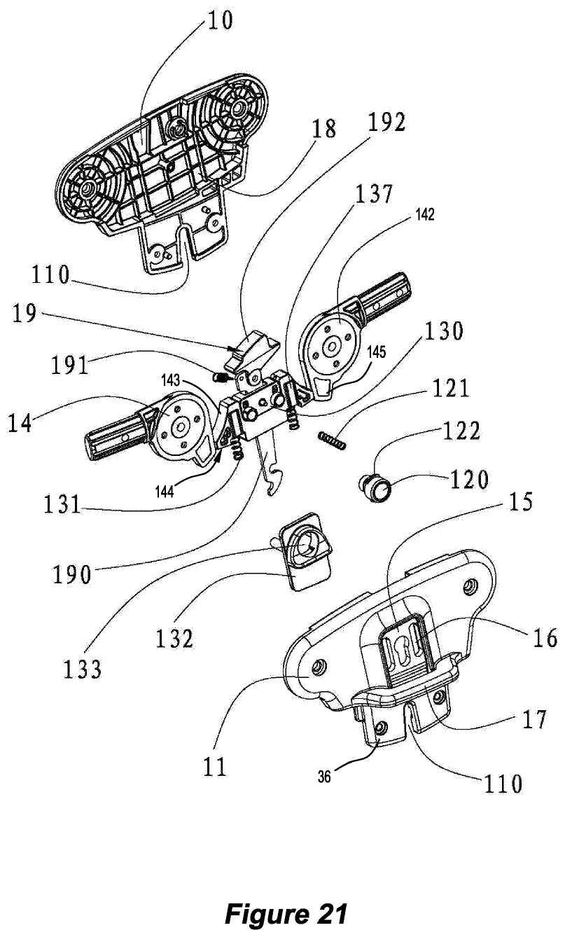

FIGS. 20 and 21 show the features of a central side mount 1 in isolation. Each of the central side mounts has a mounting tongue 36 which is received in the mounting recess 32 of the corresponding bassinet adaptor. The mounting tongue has a slot to expose the biased retaining hook 110. The leading edge of the retaining hook 110 engages the top of a retaining boss 35 formed within the mounting recess 32 of the bassinet adaptors 30. The leading edge moves the retaining hook 190 to one side against the bias of return spring 191 until the spring bias urges the hook 190 around the retaining boss 35 to securely hold the bassinet on the stroller. The weight of a baby in the bassinet is transferred through the flanges 17 of each of the central side mounts 1 onto the relatively wide top surfaces 33 of the bassinet adaptors 30.

An inner plate 10 and an outer plate 11 hingedly mount a first rim mount 14 and second rim mount 142 for rotation about spaced hinge axes. It will be appreciated that the tubular ends of the first rim and the second rim attach to the corresponding extensions of the first and second rims mounts respectively. These extensions protrude from between the inner and outer plates 10 and 11. The inner and outer plates together form the mounting tongue 36 which, as discussed above, plugs into the mounting aperture 32 of the bassinet adaptors 30.

To remove the bassinet from the stroller, the user presses the lock release button 19 to the right (as shown in FIG. 20). This rotates the latch arm about the latch pivot 18 such that the hook 193 disengages from the locking boss 35. With the convenient finger grip provided by the underside of the wedge slide button 13, the bassinet is conveniently lifted upwards and out of the mounting aperture 32 of the bassinet adaptors 30.

The process of folding the bassinet frame will now be described with particular reference to the exploded perspective shown in FIG. 21. To fold the bassinet frame, the bassinet must first be removed from the stroller, or at least the bassinet adaptors 30. As will be discussed in more detail below, the first and second rim mounts 14 and 142 remain locked in position whenever the central side mounts 1 are engaged the bassinet adaptors 30. This prevents the bassinet from being inadvertently folded whilst mounted to the stroller.

The first and second rim mounts 14 and 142 are hingedly mounted between the inner and outer plates 10 and 11. The hinge axis for the first rim mount is spaced from that of the second rim mount 142. Between these hinge axes is a locking plate 130 with a pair of mutually opposed locking facets 144 for contacting respective locking abutments 145 extending from each of the first and second rim mounts 14 and 142. The abutment between the locking facets 144 and the locking abutments 145 prevent the first rim mount 14 and the second rim mount 142 from rotating such that the first and second rims 20 and 21 can fold downwards. Furthermore, the first and second rim mounts 14 and 142 are prevented from rotating upwards (as shown in FIGS. 20 and 21) because of the geometry in which they are interconnected with the folding bed board 25 and 26 via the support strut assembly 23. Therefore the rim mounts 14 and 142 are locked against any rotation when engaged with the locking facets 144.

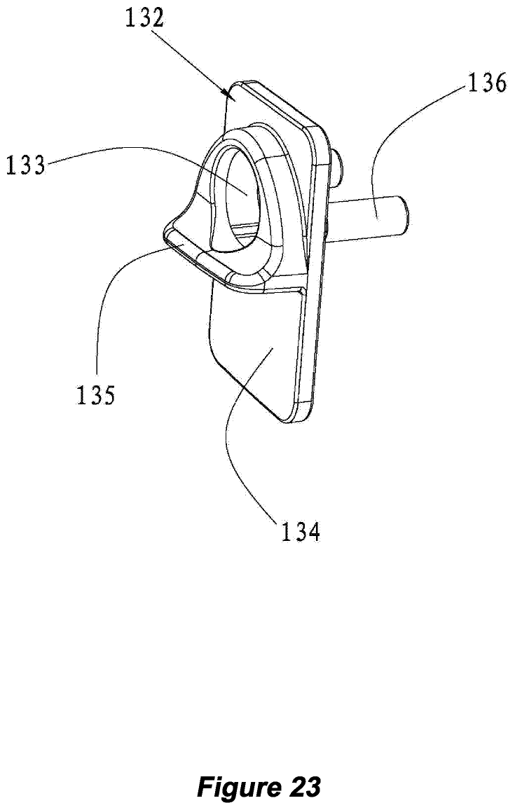

To unlock the first and second rim mounts 14 and 142, the user must first depress the slide release button 12 and then move the wedge slide button downwards to draw the locking facets 144 of the locking plate 130 out of engagement with the locking abutments 145. The slide release button 12 and the wedge slide button 13 are made up of a depressible button barrel 120, a button housing with retaining flanges 122, a button return spring 121 and a slide plate 132 with a button aperture 133. FIG. 23 best shows the features of the wedge slide moulding 134 providing the wedge slide button 13. A slide plate 132 has a thumb press flange extending from its outer side. A pair of guide lugs 136 extend from the inside of the slide plate 132. The button aperture 133 is formed directly above the thumb press flange 135 and is positioned between the guide lugs 136. Referring back to FIG. 21, the guide lugs 136 slide in the guide slots 16 formed on either side of the keyhole slot 15 provided by the outer plate 11. The depressible button barrel 120 and button retaining flanges 122 are positioned in the button aperture 133. The lugs 136 engage with complementary formations on locking plate 130 such that sliding the guide plate 132 downwards will also draw the locking plate 130 downwards.

The diameter of the depressible button barrel 120 is sized such that it will pass through the wide portion of the key hole slot 15 but not the narrow portion extending downwards from the wide portion. The wide portion of the keyhole slot 15 corresponds to the locking position of the locking plate 130 where the locking facets 144 engage the locking abutments 145. Locking plate bias springs 131 ensure that the locking plate 30 is urged into the locking position and therefore the depressible button barrel 120 is resiliently held at the wide portion of keyhole slot 15.

By depressing the button barrel 120 through the wide portion of the keyhole slot 15, the user can then press the slide plate 132 downwards using the thumb press flange 135. This in turn draws the locking plate 130 downwards against the bias of the locking plate springs 131. Once the locking facets 144 disengage from the locking abutments 145, the first and second rim mounts 14 and 142 are free to rotate downwards (using the orientation shown in FIG. 21).

On opposing sides of the locking plate 130 are curved slide surfaces 143 which ensure a smooth folding and unfolding action. Furthermore, the skilled worker in this field will appreciate that folding the first and second rims 20 and 21 downwards also forces the first and second portions (25 and 26) of the bed board to fold in a corresponding manner.

In the folded configuration, the first and second portions (25 and 26) of the bed board lie flat against each other, and sandwiched between the first and second rims (20 and 21). A clasp or simple tether provided on the soft components of the bassinet (not shown) retains the bassinet in the folded configuration during storage or transport in a vehicle.

### Retractable Canopy for a Bassinet

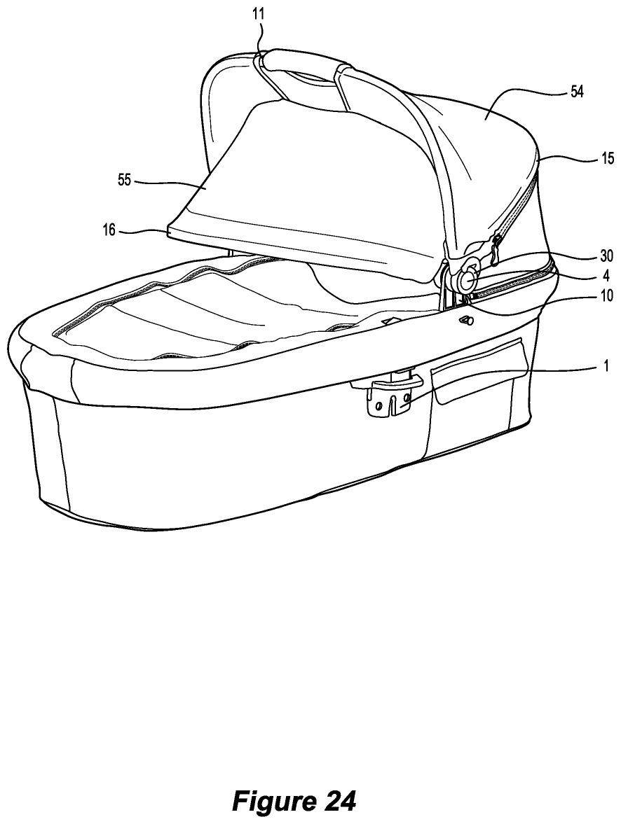

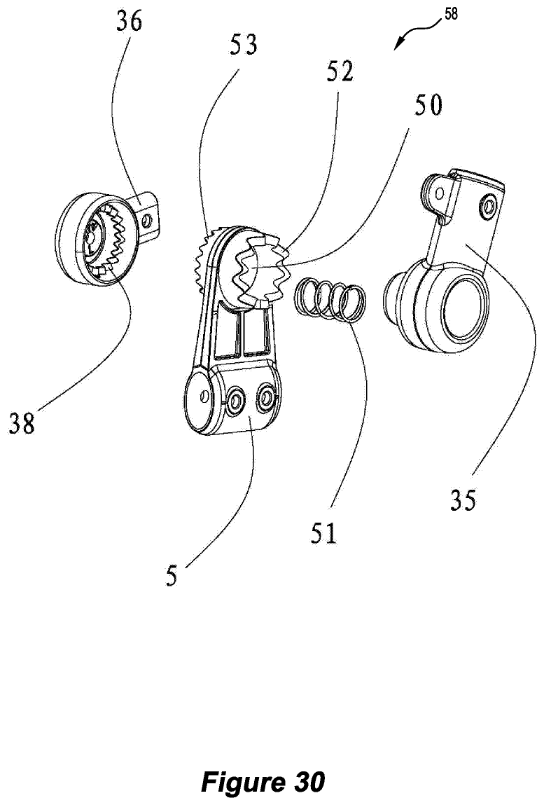

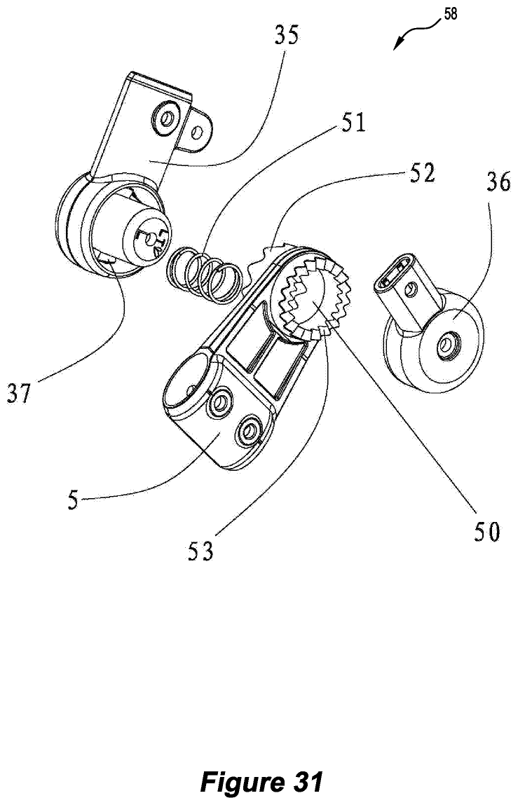

The retractable canopy attached to the bassinet will now be described with reference to FIGS. 24 to 31. Bassinets will usually have a retractable canopy to shield by baby from the sun and wind. Often the bassinet handle 11 is incorporated into the retractable canopy to simplify the design. However the handle 11 needs to be rigidly lockable in its extended position so that the bassinet can be safely carried. On the other hand, the handle also needs to rotate to a range of different positions so that the canopy can be raised or lowered to a desired degree. In light of this, some bassinets have previously used a retractable canopy with a handle that attaches to hubs positioned at either side of the bassinet. These hubs will each incorporate a lock mechanism for maintaining the handle at an extended (or carrying) position, as well as inter-engaging formations such as pairs of toothed rings for incremental or stepped movement of the canopy to intermediate positions between the retracted and extended positions.

Some known bassinet canopies also have a sun visor for additional shade protection. These visors extend from the canopy where they are simply hanged to shade the infant. It would be beneficial if the sun visor could also be positioned at a range of different extensions to provide greater flexibility of use. However incorporating additional sets of opposed toothed rings within the existing canopy hubs would make the hubs impractically large. The retractable bassinet canopy shown in FIGS. 24 to 31 addresses this by providing the handle lock in one hub and the opposing pairs of toothed rings for the handle and the visor in the other hub. This allows both hubs to remain relatively compact.

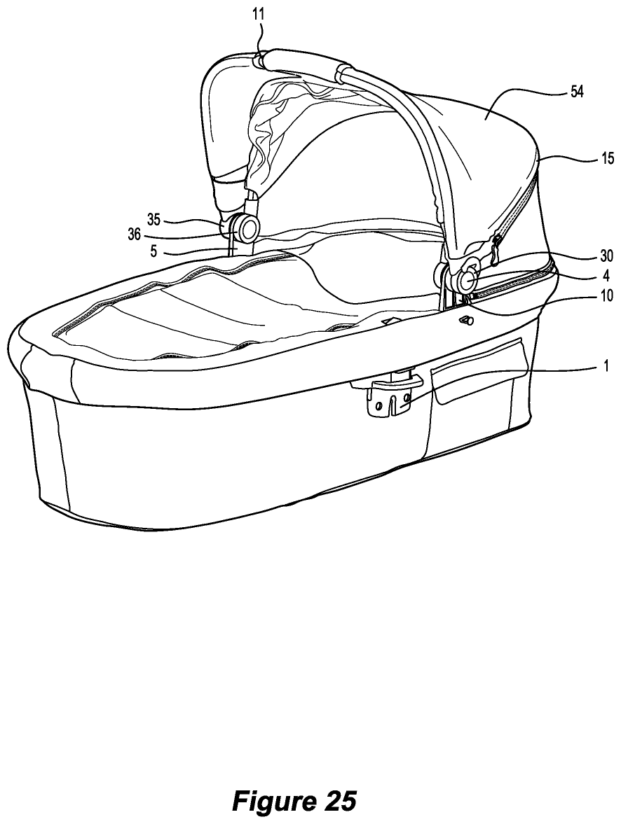

FIG. 24 is a perspective of the bassinet with the retractable canopy in its extended position and the sun visor 55 also in an extended position. FIG. 25 shows the bassinet with the sun visor retracted beneath the extended canopy.

In both FIGS. 24 and 25 the bassinet handle 11 is in the extended position with the canopy material 54 stretched taut between the rim of the bassinet, the canopy rib 15 and the handle 11. The retractable canopy frame attaches to the bassinet via a first frame attachment piece 10 on one side of the bassinet and a second frame attachment piece 5 on the other side of the bassinet. Each end of the handle 11 attaches to a first handle mount 30 and a second handle mount 35 respectively. First handle mount 30 and second handle mount 35 are rotatably connected to the first frame attachment piece 10 and the second frame attachment piece 5 respectively. Similarly the visor rib 16 is hinged to the first frame attachment piece 10 and second frame attachment piece 5 via the first visor mount 33 and second visor mount 36 respectively.

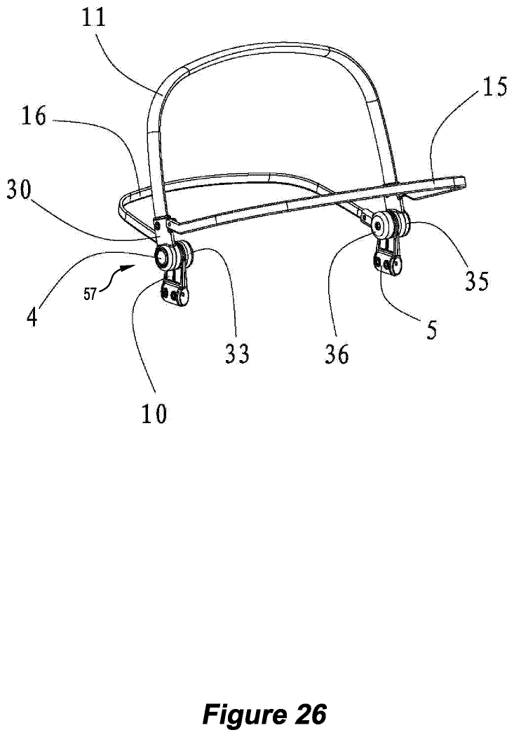

Referring to FIGS. 26 to 31, the retractable canopy frame assembly 56 is shown in isolation without the flexible canopy material 54 or the visor material 55. The canopy frame 56 has a first hub 57 and second hub 58 which together define the hinge axis for the handle 11 and the visor rib 16. The first hub 57 has the first handle mount 30, the first frame attachment piece 10 and the first visor mount 33. Likewise the second hub 58 has the second handle mount 35, the second frame attachment piece 5 and the second visor mount 36. However the first hub 57 also has the user actuated lock release button 4 and the lock mechanism (described below) for locking the handle 11 in the extended or retracted positions. The second hub 58 has two pairs of inter-engaging toothed rings (described below) which define the incrementally stepped positions between fully retracted and fully extended, for both the canopy and the visor.

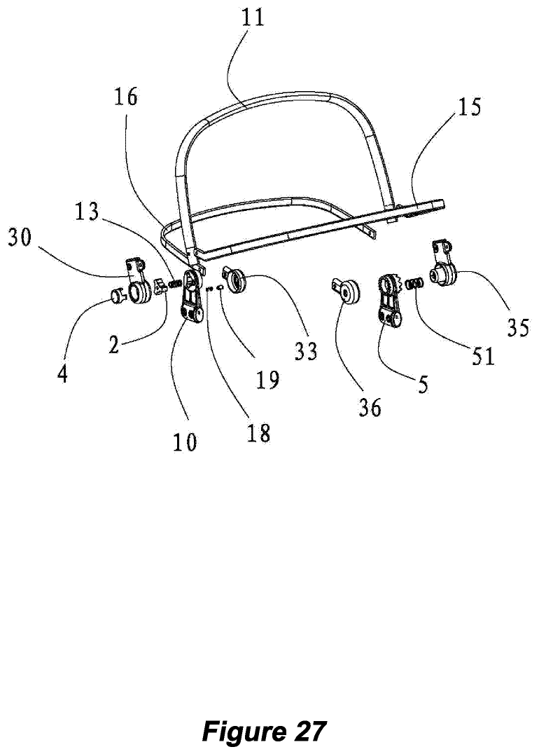

FIGS. 27, 28, and 29 show the components of the first hub 58 in an exploded perspective. The lock release button 4, movable locking element 2, lock bias spring 13, lock recess 31, and corresponding lock recess 12 provide a handle lock assembly that releasably locks the handle in its extended or retracted positions. The lock release button 4 has three equally spaced push prongs 40 extending in the button push direction. The push prongs 40 extend through respective prong apertures 32 within the lock recess 31 formed in the first handle mount 30. Retention barbs 41 formed on the distal ends of each push prong 40 retain the lock release button 4 on the first handle mount 30. A lock bias spring 13 urges the movable locking element 2 into a locked position sitting partially within the lock recess 31 and partially within the corresponding lock recess 12 in the first frame attachment piece 10. In this locked position, the equi-spaced radial arms 21 extending from the lock body 20 are keyed into both the lock recess 31 and the aligned radial arm recess 14 of the corresponding lock recess 12 such that the first handle mount 30 and first frame attachment piece 10 are locked together preventing any relative rotation.

Pressing the lock release button 4 pushes the movable locking element 2 out of the lock recess 31 against the bias of the lock spring 13 such that it is completely within the corresponding lock recess 12. In this unlocked position, relative rotation between the first handle mount 30 and the first frame attachment piece 10 is possible. Having pushed the movable locking element to the unlocking position within the corresponding lock recess 12, and rotated the handle out of the extended or retracted position, the user can release the lock release button 4 which will automatically return to the locked position when the equi-spaced radial arms 21 once more align with the lock recess 31 in the first handle mount 30. This is configured to occur in either the extended position or retracted position of the handle 11.

The first hub 57 is also provided with an auxiliary visor hold mechanism to bolster the operation of the inter-engaging toothed rings in the second hub 58 primarily responsible for defining the incrementally stepped visor positions (described below).

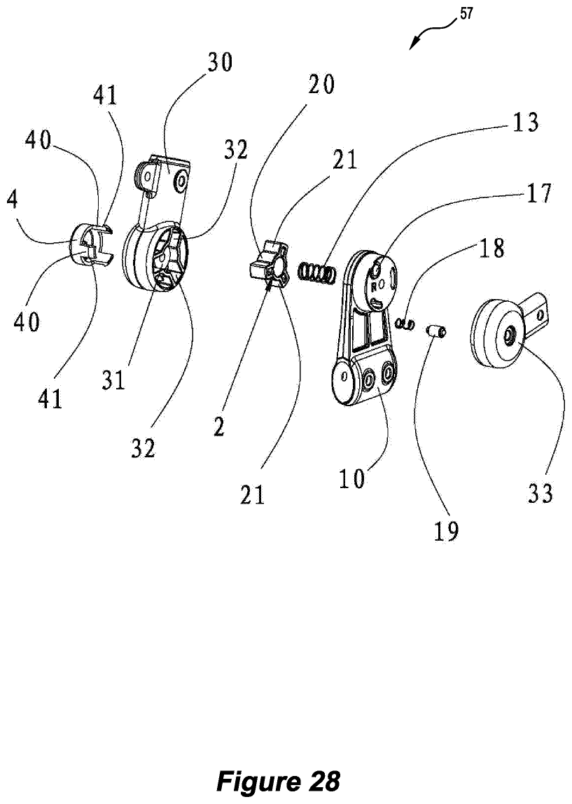

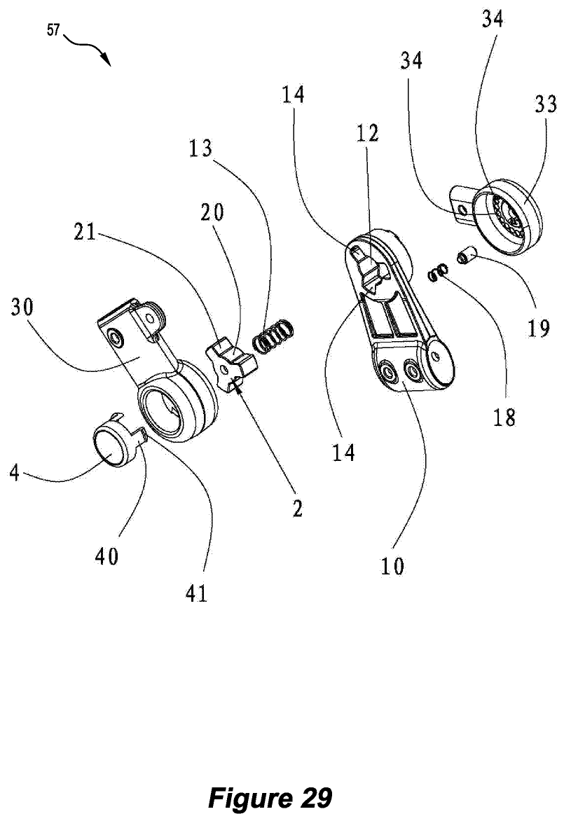

As best shown in FIG. 28, the inward facing side of the first frame attachment piece 10 has a visor hold recess 17 that accommodates a visor hold spring 18 acting on a visor hold element 19. Referring to FIG. 29, the first visor mount 33 has a ring of dimples 34 for engagement with the partially spherical end of the visor hold element 19. Biasing the visor hold element 19 into each dimple in the ring 35 helps to maintain the first visor mount 33 in each of the incrementally stepped locations of the visor, along with the interaction of the visor's pair of toothed rings in the second hub 58 (described below).

FIGS. 27, 30 and 31 show the features of the second hub 58. Within the second visor mount 36 is a rotating visor toothed ring 38 for interengagement with a fixed visor toothed ring 53 formed on the second frame attachment piece 5. On the inside of the second handle mount 35 is a rotating handle toothed ring 37 for inter-engagement with a fixed handle toothed ring 52 provided on the second frame attachment piece 5. Sequential engagement and disengagement of the opposing teeth on the pair of toothed rings 37 and 52 defines the incrementally stepped positions at which the handle (and therefore the canopy) can sit between the retracted and extended positions. Likewise successive engagement and disengagement of the visor's pair of toothed gears 38 and 53 set the incrementally stepped positions at which the user can set the visor 55. The opposing teeth on each of the toothed rings 38, 53, 52 and 37 have a rounded or sinusoidal-like profile to allow opposing teeth to slide over each other when sufficient torque applied. With any applied torque, the tooth rings are biased into engagement with each other.

The second handle mount 35 has a central boss extending into a central aperture 50 through the fixed handle toothed ring 52 and the fixed visor toothed ring 53. A second hub spring 51 biases the second visor mount 36 away from the second handle mount 35 which are both connected together to allow a small degree of relative movement. In this way, the second handle mount 35 and the second visor mount 36 have some axial displacement to accommodate the sequential engagement and disengagement of the opposing toothed rings (30 and 52, 53 and 38).

It will be appreciated that the first and second hubs 57 and 58 further include a pin (not shown) providing a hinge axle for each of the hubs respectively. Furthermore the skilled worker will readily understand that the canopy rib 15 is freely hinged to the apertured lugs extending from the side of the first handle mount 30 and the second handle mount 35.

### Adjustable Foot Rest

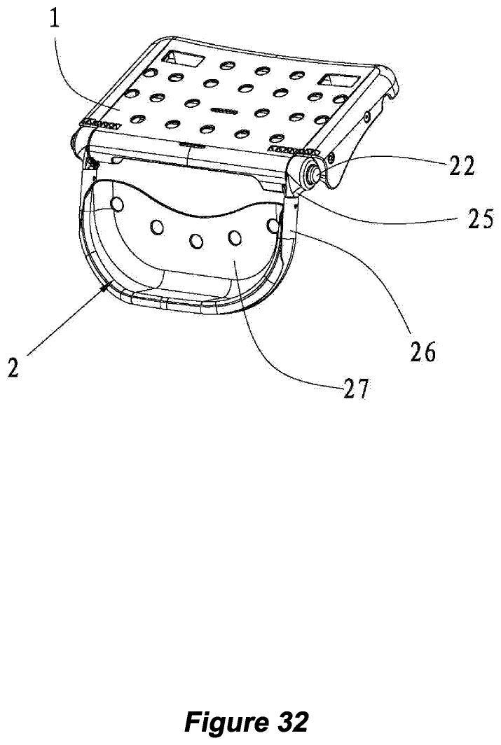

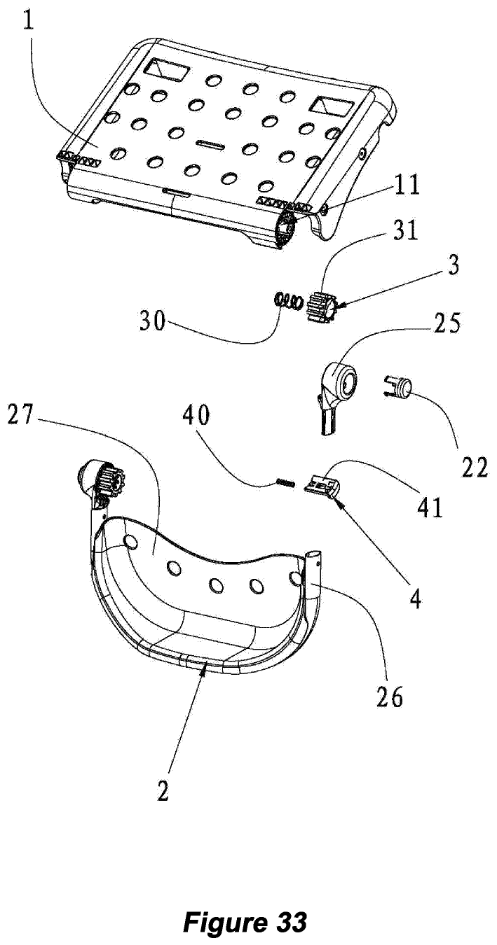

The adjustable foot rest will now be described in detail with a particular reference to FIGS. 32 to 37. FIGS. 32 and 33 show the seat base 1 and the footrest 2 in isolation from the rest of the stroller in the interests of clarity. As best shown in the exploded perspective of FIG. 33, the footrest 2 has a footrest rim 26 for supporting a foot support tray 27. At either end of the u-shaped footrest rim 26 is a footrest rim mount 25 configured for hinged connection to the front edge of the seat base 1.

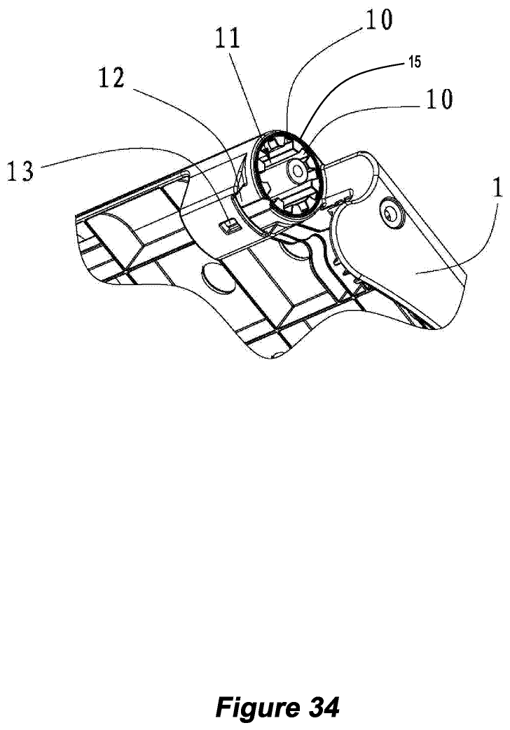

The front edge of the seat base 1 has a pair of outwardly facing hinge axles 11 (only one hinge axle visible) which together define the hinge axis about which the footrest 2 rotates. Each hinge axle 11 is fixed in a tubular housing extending along the front edge of a seat base 1 such that it is tangential with the sitting surface. Within the tubular housing 14 and 15 are inwardly facing fixed spline formations 10 as best shown in FIG. 34.

Likewise the footrest rim mount 25 also has fixed footrest spine formations 20. These fixed spline formations 10 and 20 are configured to mesh with the splines 31 on the footrest spline gear 3. The spline gear 3 is mounted for rotation on the hinge axle 11 and biased into a locking position where the splines 31 partially engage the seat splines 10 and partially engage the footrest splines 20 to lock the footrest against rotation.

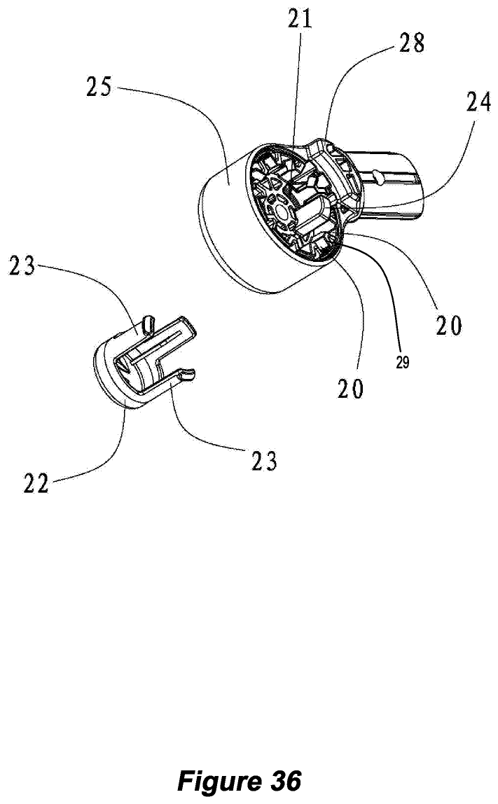

To adjust the footrest 2, lock release buttons 20 provided on both the footrest rim mounts 25 are simultaneously pushed axially inwards. As best shown in FIG. 36, the barbed push prongs 23 extending from the buttons 22 push the spline gear 3 into the hinge axle tubular housings 14 and 15 against the bias of the hinge spring 30. This disengages the splines 31 of the spline gear from the footrest splines 20 within the footrest rim mount 25. This allows the footrest to freely rotate on the hinge axles 11. When the position of the footrest 2 has been adjusted, the lock release buttons 22 are released and hinge spring 30 urges the spline gear 3 back to the locked position. Edge tapers 35 on the outer ends of the spline ridges 33 extending from the spline body 32, slidingly engage corresponding tapered surfaces 29 on the inner ends of the footrest splines 20.

This sliding engagement between the two tapered sections precisely positions the footrest 2 at one of the predetermined positions at which the footrest will not impede the smooth folding or unfolding of the stroller.

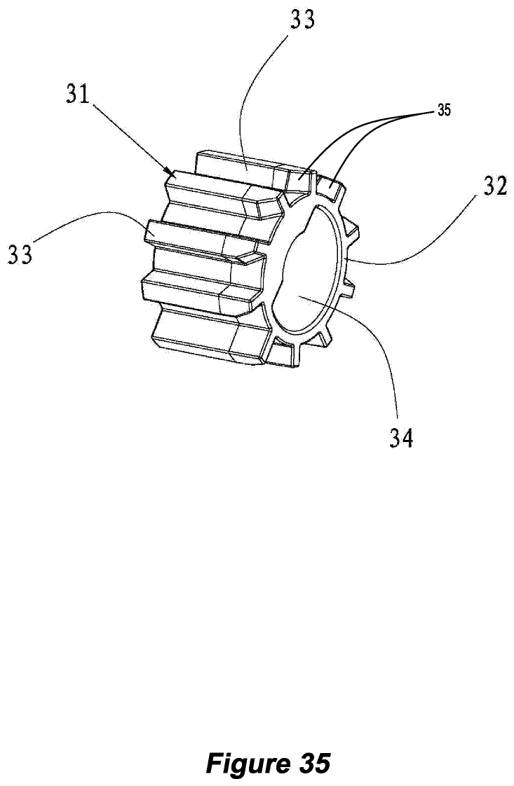

The angular travel of the footrest 2 is limited by the angular travel stop 24 sliding within the slot 21 of the footrest rim mounts 25 and within the asymmetric hinge axle aperture 32 of the spline gear 3 (best shown in FIG. 35). It will be appreciated that the angular travel step 24 slidingly engages the interior surface of the hinge axle aperture 34 and helps to support the spline body 32 when urged into the locked position.

When the child is older and physically big enough to no longer need the adjustable footrest, the footrest can be moved to a retracted position extending beneath the seat base 1. In this position it does not contact the child's legs who now place his or her feet on the tread surface above the front wheel assembly.

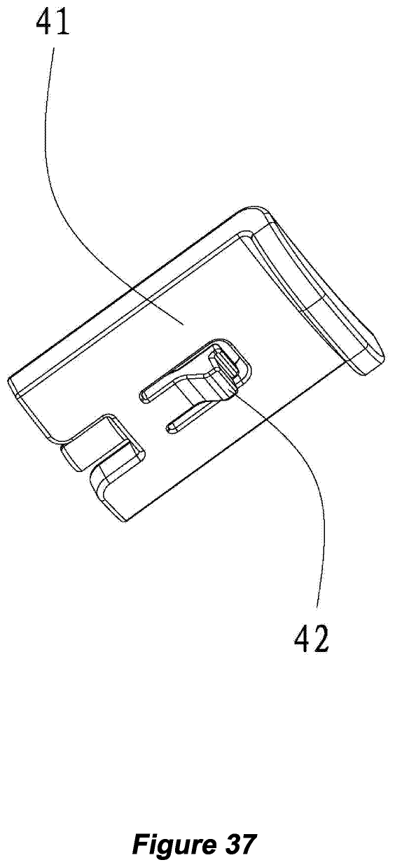

To move the footrest 2 to the fully retracted position, the user must first press the retraction lock button 42 best shown in FIG. 37. Beneath the tubular housing 15 is a slide chute 12 with a slide button aperture 13 for receiving the retraction lock button 42 resiliently mounted to the slide plate 41. The full retraction abutment 4 extends from an outer end of the slide plate 41 when the footrest is in use (i.e. not moved to the fully retracted position), the camming abutment 28 formed on the inner surface of the footrest rim mount 25 engages the full retraction abutment 4 to prevent rotation of the footrest 2 into the fully retracted position. By manually depressing the retraction lock button 42 into the slide aperture 13 of the slide chute 12, the slide plate 41 is able to slide within the slide chute 12 against the bias of the retraction button spring 40. Sliding interaction between the full retraction abutment 4 and the camming abutment 28 forces the slide plate to retract into the slide chute 12 and allow the footrest to fold under the seat base 1 to the fully retracted position.

At the fully retracted position, the full retraction abutment 4 once again slides past the camming abutment 28 as the retraction button spring 40 pushes the slide plate 41 outwards. This allows the retraction lock button 42 to resiliently extend back throughout the slide button aperture 13 so that the footrest 2 is held in the fully retracted position, not just by the inter-engaging splines, but also the full retraction abutment 4 and the camming abutment 28. In this way the footrest does not need to be removed when it is outgrown. This avoids the risk of a detachable footrest being lost or misplaced.

### Seat Reclining Mechanism

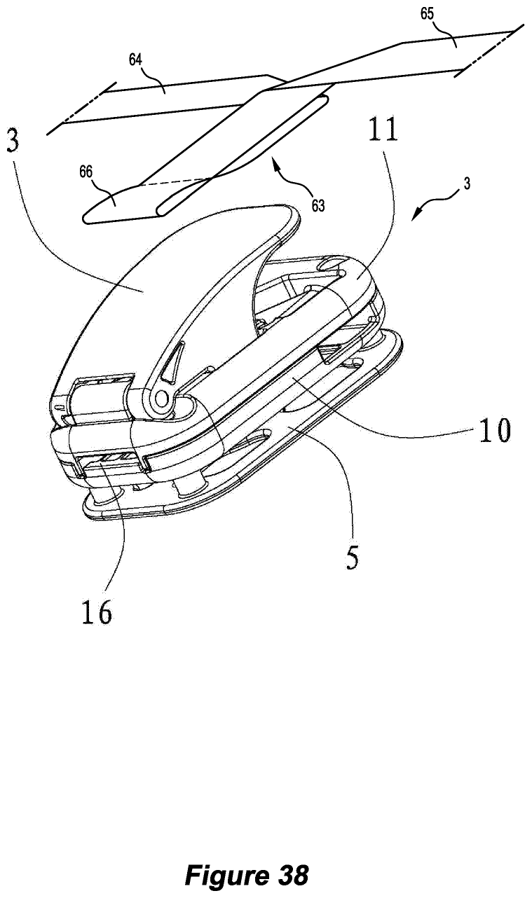

The seat reclining mechanism for the collapsible stroller will now be described with particular references to FIGS. 38 to 42. FIG. 38 shows the seat clamp 3 and the first and second seat reclining straps 64 and 65 in isolation in the interests of clarity. The first and second seat reclining straps 64 and 65 are shown folded into the configuration they would generally adopt when fed through the strap path of the seat clamp 3.

Referring briefly back to FIG. 1, the first strap is adapted to attach to the collar 130 on the frame element 108 extending from one end of the handle 102. The second strap 65 attaches to the collar 131 fixed to the frame element 108 extending from the other end of the handle.

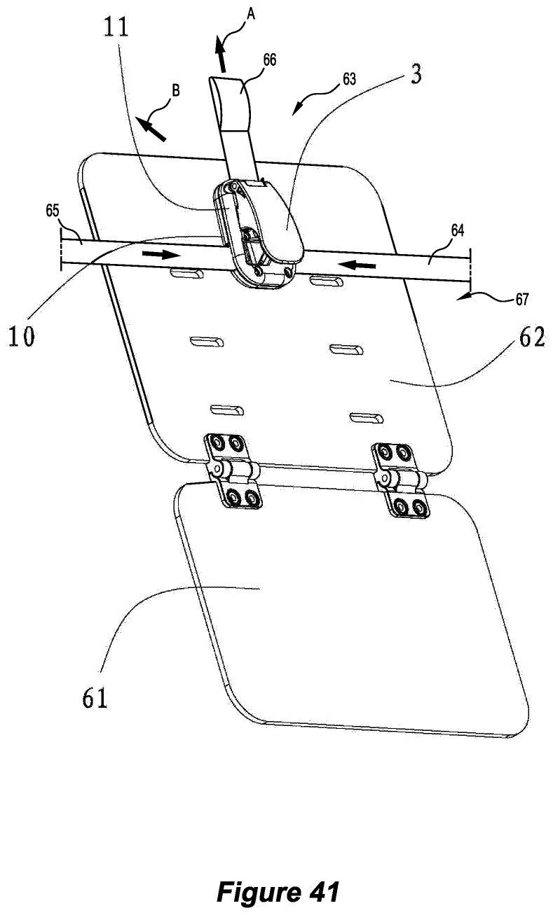

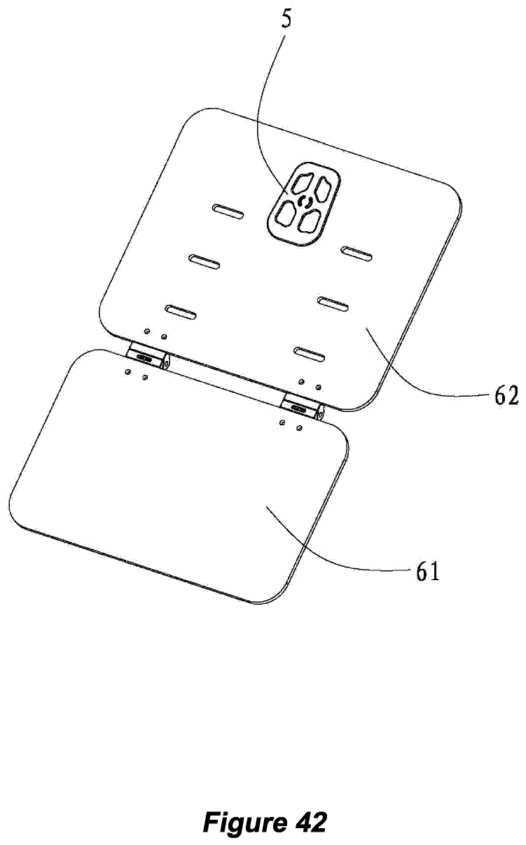

The first and second straps 64 and 65 enter the seat clamp 3 through apertures on opposing sides. The seat clamp 3 has a clamp body made up of a first body portion 10 and second body portion 11. Within the clamp body, the first and second straps wrap around respective folding edges (discussed below) to provide a pair of overlapping straps 63. At the end of the overlapping straps 63 is a lifting loop 66 for the user to grip. A portion of the lifting loop 66 will always protrude from the combined strap aperture 16 of the seat clamp 3. Seat clamp 3 is rigidly attached to the rear of the upper seat back panel 62 by the mounting plate 5 (see FIGS. 41 and 42).

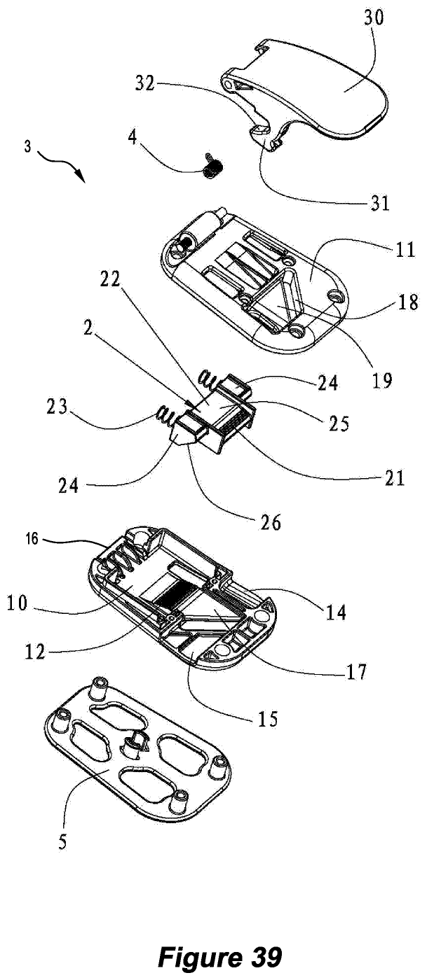

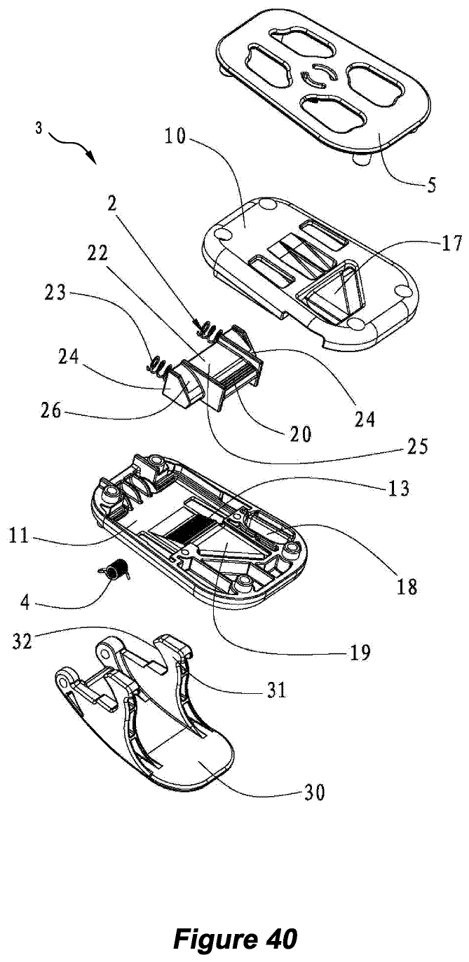

Referring to FIGS. 39 and 40, exploded perspectives of the seat clamp 3 are shown from opposing angles. As discussed above, the clamp body has a first body portion 10 and second body portion 12 that fit together in a clam shell manner such that the wedge clamp 2 sits in between. The first strap enters the clamp body 3 and folds around the first strap folding edge 17 formed in the first body portion 10. Similarly the second strap enters the other side of the clamp body 3 and folds about the second strap folding edge 18 formed in second body portion 11.

This brings both straps into overlapping relationship and extending along feed chute 19 defining a path to the wedge clamp 2. The wedge clamp 2 has a wedge body 22 with a first strap wedge surface 20 positioned at an angle to the second strap wedge surface 21. Similarly the first body portion 10 has a first strap friction surface 12 and the second body portion 11 has a second strap friction surface 13 configured at an angle corresponding to that of the first and second strap wedge surfaces (20 and 21).

Clamping bias springs 23 press into respective spring housings 24 formed on either side of the wedge body 22. This urges the wedge body 22, and in particular the first and second strap wedge surfaces 20 and 21, towards the first and second strap friction surfaces 12 and 13. It will be appreciated that the wedge surfaces 20 and 21, and the friction surfaces 12 and 13, have surface formations and/or coatings for enhanced grip on the first and second straps. The overlapping first and second straps divide to pass over either side of the wedge body 22, then reunite as they exit the combined strap apertures 16.

Seat clamp 3 has a manual release actuator in the form of a lift lever 30 hinged to the clamp body. Torsion spring 4 places a rotational bias on the lift lever 30 to press the support feet 31 into the upper seat back panel 62 through apertures formed in the first body portion 10. The lift lever 30 also has retraction slide surfaces 32 which engage complementary slide surfaces 26 formed on the spring housings 24 of the wedge clamp 2.

By lifting the lift lever 30 against the bias of the torsion spring 4, the retraction slide surfaces 32 slide over the complementary surfaces 26 to push the wedge clamp away from the first and second strap friction surfaces 12 and 13 against the bias of clamping springs 23. With the clamping pressure on the first and second straps removed, or reduced, the first and second straps can be drawn in through the aperture 16 and fed out the opposing sides of the seat clamp 3 to move the seat back to the reclined position.

As the lift lever 30 is in effect a ‘second class’ lever (i.e. the load is applied between the fulcrum and the lift force), it provides a mechanical advantage when moving the wedge clamp 2 against the bias of the clamping springs 23. This mechanical advantage reduces the lift force required and allows operation of the seat clamp with a single hand, possibly while continuing to push the stroller without interrupting the motion of the stroller. This reduces the chance of disturbing a child that has only just fallen asleep.

Similarly the seat back can be moved to the upright position using a single hand by pulling on the lifting loop 66 of the overlapping straps 63 extending from the combined strap aperture 16. The tension applied to the first and second straps 64 and 65 extending on each side of the wedge body 22 moves the wedge clamp to out of clamping engagement against the bias of the clamping springs 23. The seat back is lifted to its upright position using only one hand pulling on the lifting loop 66 while the stroller is pushed with the other hand.

### Snack Tray

A detachable snack tray 44 is shown in FIGS. 43 to 50. The snack tray has a snap locking formation 1 for releasably attaching to the frame assembly of the stroller 100 (see FIG. 1). Typically, the snack tray will attach to the safety bar 62 extending in front of the child seated in the stroller (see FIG. 14). However, the snack tray may also be attached to the handle 102 by first removing the central snap on plastic cover 102a (see FIG. 1). The frame assembly may be provided with the mounting sleeve 3 at the desired mounting site so that the snack tray 44 has greater positional stability when attached.

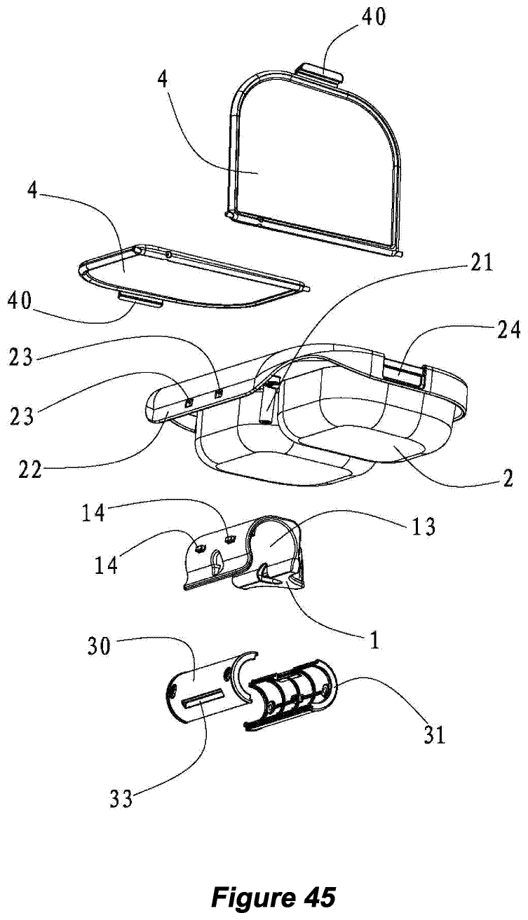

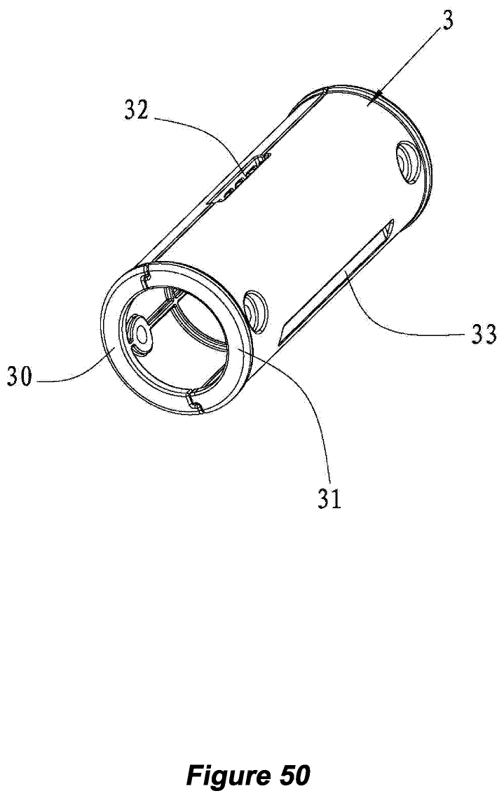

As best shown in FIG. 45, the snack tray 44 has a snap locking formation 1 with a central frame recess 13 to fit over the frame, or as shown the mounting sleeve 3. The mounting sleeve 3 has a sleeve first half 30 and a sleeve second half 31 which clamp together about the frame. As best shown in FIG. 50, the first and second halves 30 and 31 define an anchor cavity 32. The first and second halves 30 and 31 also each define a surface channel 33.

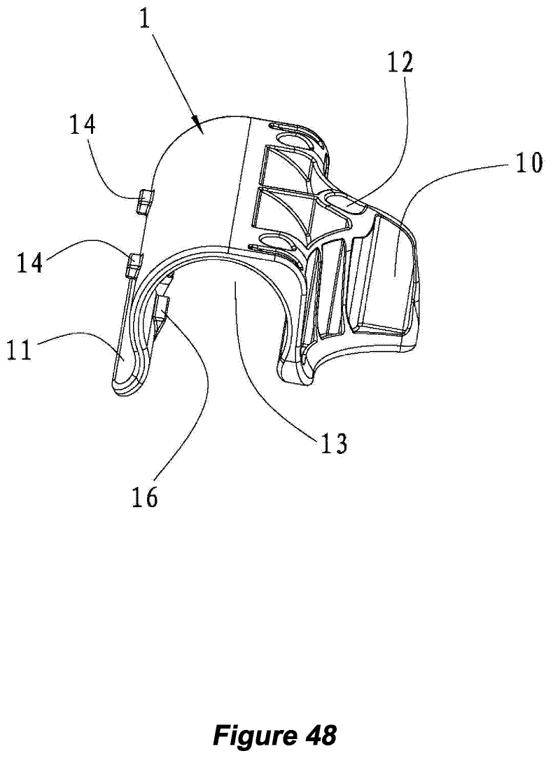

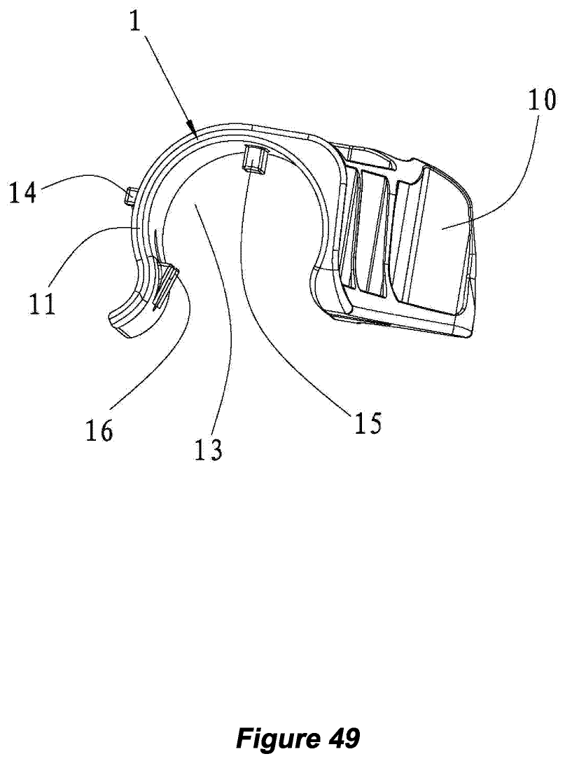

As shown in FIGS. 48 and 49, the snap locking formation 1 has internal barbed clips 16 and a rotation anchor 15 extending into the frame recess 13. When the snack tray 44 is attached to the mounting sleeve 3, the snap locking formation is pushed over the sleeve such that the rotation anchor 15 engages the anchor cavity 32. Meanwhile, the resilient tongue 11 allows the internal barbed clips to slide over the exterior of the sleeve until they click into the surface channel 33 on either the sleeve first half 30 or the sleeve second half 31. The resilient bias provided by the tongue 11 ensures the snap locking formation grips the sleeve 3 while the rotation anchor 15 and the internal barbed clips 16 ensure the snack tray remains in a stable position.

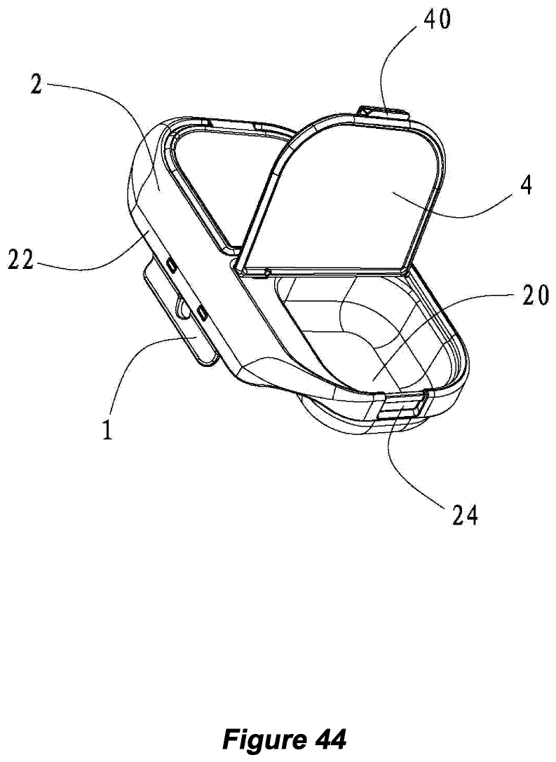

It will appreciated that the curved end of the resilient tongue 11 can be used to pry the snap locking formation of the sleeve to detach the snack tray 44 so that it can be turned 180° and reattached to the sleeve such that the internal barbed clips 16 engage the surface channel 33 on the opposing half of the sleeve 3. As best shown in FIGS. 44 and 45 the tray 2 has two shallow recesses 20 each covered by a hinged lid 4. Along one side of the tray recesses 20 is a curved slide flange 22. Extending beneath the curved side flange 22 is a mounting spigot 21 which is received in the mounting cavity 12 of the snap locking formation 1. The mounting cavity 12 extends upwards from a tray supporting base 10 on the snap locking formation 1 (see FIG. 48) to provide a solid support beneath the tray 2.

The tray 2 is attached to the snap locking formation 1 by inserting the mounting spigot 21 into the mounting cavity 12 so that the curved side flange 22 slides over the locating features 14 until they snap into the locating apertures 23. It will be appreciated that the tray is offset to one side of the snap locking formation 1 and generally cantilevered out from the sleeve 3. Accordingly, the curved side flange 22 and mounting spigot 21 need to be robust enough to withstand the normal loading that a child might apply to the outer cantilever side of the tray 2.

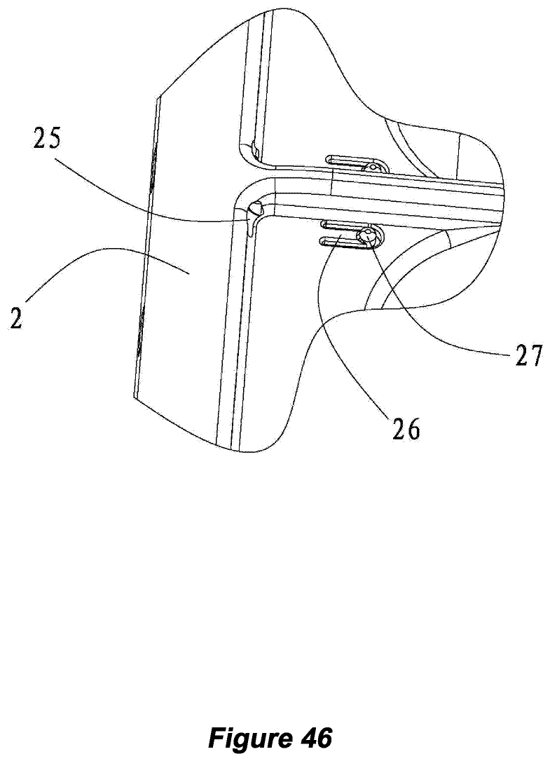

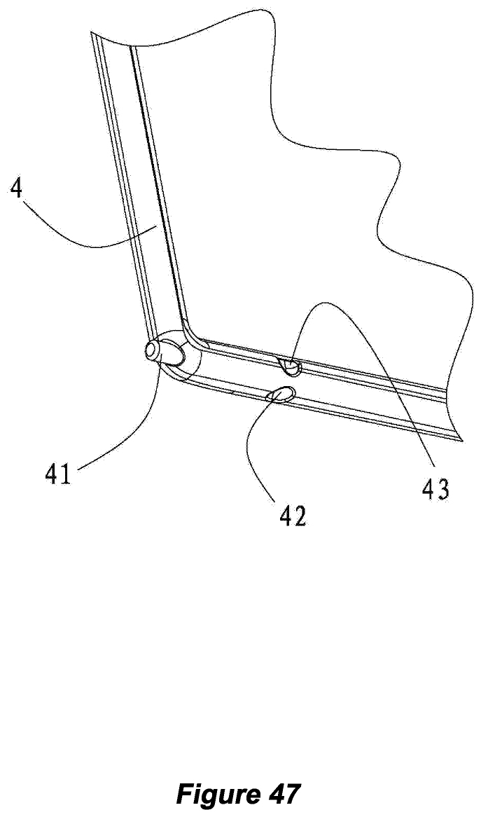

The hinged lids 4 are configured such their hinge axis extend generally towards the child so that the lid does not obstruct access to the tray recesses 20 regardless of which position the snack tray 44 is attached to the mounting sleeve 3. Furthermore, as best shown in FIG. 46, the tray 2 has a lid hinge cavity 25 to receive the lid hinge extension 41 shown in FIG. 47. Furthermore, the tray 2 has an integrally formed cantilevered arm 26 with a biased lid holder 27 formed at its end. This bias lid holder 27 is urged into engagement with the raised lid recess 42 or the closed lid recess 43 to lightly hold the lid for in the raised or closed position respectively. Lightly holding the lid in a raised position allows the child easier access to the snacks within the shallow recesses 20.

The hinged lids 4 also have a lid latch 40 for co-operative engagement with a latch detent 24 formed in the outer rim of the tray 2. The lid latch 40 provides a more secure closure for the lid and may be used to restrict access to snacks within the tray particularly if the child is a toddler or very young.

It will appreciated that the tray 2 can be made of dishwasher safe plastic and easily removed from the snap locking formation for the purposes of cleaning. Similarly, the entire snack tray 44 may be detached and turned three 180°, the reattached such that the tray is closer or further from the child. This allows the ergonomics of the tray position to be optimised for the age of the child.

Similarly, the snack tray 44 can be removed from the safety bar 62 (see FIG. 14) and attached to the handle 102 (see FIG. 1) to extend forward of the handle or rearwards of the handle depending on the users preference. Furthermore, in the collapsible stroller frame assembly 100 described herein, the stroller can be folded without first removing the snack tray from the safety bar 62 or the handle 102, regardless of the snack tray orientation.

The inventive aspects of the collapsible stroller and folding bassinet have been described herein by way of example only. Skilled workers in this field will readily recognise many variations and modifications of the specific mechanisms disclosed herein, which do not depart from the spirit and scope of any broad inventive concepts.

1. A collapsible stroller frame assembly selectively configurable in an unfolded configuration for carrying a child or infant, and a folded configuration for compact storage or transport in a vehicle, comprising:
a front wheel frame with a front wheel assembly;
a rear wheel frame with a rear wheel assembly;
a lower hinge for hingedly connecting the front wheel frame to the rear wheel frame,
a seat frame hingedly connected to the lower hinge;
an upper hinge connected to the seat frame at a position spaced from the lower hinge;
a handle frame connected to the upper hinge,
a manual release for user actuation; and
a mechanical link between the upper and lower hinges; wherein
the lower hinge is lockable to hold the seat frame, the front wheel frame and the rear wheel frame in the unfolded configuration, and unlockable to allow relative rotation of the seat frame, the front wheel frame and the rear wheel frame into the folded configuration; and
the upper hinge is lockable to hold the handle frame and the seat frame in the unfolded configuration, and unlockable to allow rotation of the handle frame relative to the seat frame into the folded configuration; such that use actuation of the manual release unlocks the upper hinge for rotation of the handle frame relative to the seat frame, and the mechanical link unlocks the lower hinge in response to a predetermined angular rotation of the handle frame relative to the seat frame.

2. A frame assembly according to claim 1, wherein the handle frame supports the user actuated release for unlocking the upper hinge.

3. A frame assembly according to claim 2, wherein the handle frame has two spaced apart, generally upright frame members connected at their upper ends via a cross member forming a handle, and the user actuated release has a pair of retractable triggers, one of the retractable triggers being positioned on each of the spaced apart frame members respectively, proximate the handle.

4. A frame assembly according to claim 3, wherein the handle frame is telescopic such that simultaneous retraction of both the retractable triggers enables the handle to telescope towards the upper hinge and a portion of the user actuated release housed within the handle frame to interact with the upper hinge to unlock the upper hinge.

5. A frame assembly according to claim 4, wherein the handle frame is rotatable towards the rear-wheel frame in response to unlocking the upper hinge.

6. A frame assembly according to claim 5, wherein the handle frame is approximately parallel to the wheel base when at the predetermined angular rotation between the handle frame and the seat frame, at which point the mechanical link between the upper hinge and the lower hinge unlocks the lower hinge such that the seat frame is rotatable towards the front wheel frame.

7. A frame assembly according to claim 6, wherein the frame assembly further comprises a latch for releasably securing the front wheel frame, the rear wheel frame, the seat frame and the handle frame in the folded configuration, wherein during use the latch automatically secures the frame assembly upon movement to the folded configuration.

8. A frame assembly according to claim 7, wherein the latch comprises a spigot extending from the seat frame, a hook formation extending from the handle frame and a hasp extending from the rear wheel frame wherein the hook engages the spigot at a mid point, and the hasp engages with an end of the spigot.

9. A frame assembly according to claim 8, wherein the spigot is mounted for movement between a frame secured position and a frame released position, wherein the spigot is biased to the frame secured position, and manual actuation of the spigot to the release position allows the frame assembly to move to the unfolded configuration, wherein the hook preferably engages the spigot upon rotation of the handle frame and the seat frame to overlay the front wheel frame.

10. A frame assembly according to claim 9, wherein the frame assembly is configured and weighted such that user lifting of the handle upwards after the hook engages the spigot draws the lower hinge upwards to rotate the rear wheel frame towards the front wheel frame via gravity.

11. A frame assembly according to any one of claim 1, wherein the frame assembly further comprises a safety bar for hinged attachment to the handle frame wherein during use the safety bar extends forward to surround and protect a child sitting in the stroller seat.

12. A frame assembly according to claim 11, wherein the safety bar is configured to be folded upwards to lie flush against the handle frame such that the frame assembly can be moved to its folded configuration without first detaching the safety bar.

13. A frame assembly according to any one of claim 1, wherein the frame assembly further comprises a retractable hood pivotally attached to the handle frame to extend above the seat for weather and sun protection.

14. A frame assembly according to claim 13, wherein the retractable hood is retractable such as to lie flat against the handle frame when moving the frame assembly towards its folded configuration.

15. A frame assembly according to any one of claim 1, wherein the seat base has a footrest extending from a hinge mechanism at a front edge of the seat base.

16. A frame assembly according to claim 15, wherein the hinge mechanism for the foot rest is devised for the footrest to adopt one of a predetermined range of discretely different angles relative to the plane of the seat, the footrest remaining in any one of the predetermined range of different angles as the frame assembly is moved to the folded configuration.

17. A frame assembly according to any one of claim 1, wherein the handle frame includes telescopic frame members enabling the handle to move closer to the upper hinge when the frame assembly is in the folded configuration.

18. A frame assembly according to any one of claim 1, wherein
the frame assembly comprises a snack tray having a tray with at least one shallow recess for holding snacks during use of the stroller, and a snap locking formation positioned to one side of the tray for snap locking engagement with the safety bar.

19. A frame assembly according to claim 18, wherein the snack tray is configured such that the snap locking formation is capable of snap locking the snack tray to the safety bar with the tray selectively extending forward of the safety bar or extending rearward of the safety bar.

20. A frame assembly according to claim 19, wherein the snack tray comprises means configured for snap locking with the handle whereby the snack tray extends forward of the handle or rearward of the handle.

21. A frame assembly according to claim 19, wherein the handle has a mounting sleeve for engagement with the snap locking formation, and wherein the safety bar has a mounting sleeve for engagement with the snap locking formation.

22. A z-foldable stroller comprising a frame assembly according to claim 21 and a folding bassinet frame assembly which comprises: a bed board having a first portion and a second portion, the first portion and the second portion from being hinged together and configured to unfold to provide a support surface for an infant; a first rim and a second rim spaced from the bed board when in an unfolded configuration, the first and second rim configured to support a side wall formed by soft components, such as textiles, of the bassinet, the side wall extending upwards from a peripheral region of the bed board to encircle the infant; a support strut assembly connecting the first rim and the second rim to the bed board; and a pair of central side mounts, each of the central side mounts connecting to the first rim and the second rim on either side of the bassinet frame assembly; wherein each of the central side mounts has a first hinge spaced from a second hinge and a locking mechanism to lock the first and second hinges such that the first and second rims are fixed relative to the bed board, and simultaneously unlock both the first and second hinges such that the first rim and the second rim rotate together with the first portion and the second portion of the bed board into a folded configuration; and wherein each of the central side mounts has mounting formations for releasable interengagement with complementary mounting formations attached to or formed integrally with components of the frame assembly.

23. Stroller according to claim 22, wherein the bassinet comprises a slide button arranged to interact with a locking mechanism which selectively locks the bassinet in its unfolded configuration, and wherein the slide button is configured to abut complementary mounting formations on the stroller frame such that the slide button is selectively prevented from displacing a movable unlocking member for folding the bassinet frame, regardless of whether a release button selectively securing the slide button against movement, is depressed, when the bassinet is mounted on the stroller frame.

24. Stroller according to claim 21, wherein the bassinette further includes a retractable canopy hinged to the bassinette frame assembly for rotating to an extended position providing weather and sun protection, and retracting to a retracted position, the canopy comprising a supporting frame and a covering of flexible material which folds in a concertina fashion when moving to the retracted position.
